(19) United States
(12) Patent Application Publication
(10) Pub. No.: US 2011/0052283 A1
(43) Pub. Date: Mar. 3, 2011

(54) HEAT GENERATING UNIT AND HEATING APPARATUS

(75) Inventors: Masanori Konishi, Kagawa (JP); Akira Nishio, Kagawa (JP); Hiroaki Matsuoka, Kagawa (JP)

(73) Assignee: PANASONIC CORPORATION, Osaka (JP)

(21) Appl. No.: 12/990,754

(22) PCT Filed: Dec. 19, 2008
(86) PCT No.: PCT/JP2008/003862

§ 371 Date: Nov. 2, 2010

(30) Foreign Application Priority Data
May 9, 2008 (JP) 2008-123401
May 9, 2008 (JP) 2008-123408

(51) Int. Cl. G03G 15/20; H05B 3/06

(52) U.S. Cl. 399/330; 219/520

(57) ABSTRACT

A heat generating element (2) in a heat generating unit has an expandable shape having: a plurality of first slits (2a) each formed at an oblique angle with respect to corresponding one of both edge portions opposing to each other along the longitudinal direction of the heat generating element; and a plurality of second slits (2b) arranged at prescribed intervals alternating with the plurality of first slits (2a) in parallel thereto. The plurality of second slits (2b) are formed at the central portion in the width direction of the heat generating element, so as to form a current path at each of edge portions respectively located between the second slits and a pair of both edge portions opposing to each other along the longitudinal direction of the heat generating element.

### TECHNICAL FIELD

The present invention relates to a heat generating unit used as a heat source and to a heating apparatus using the heat generating unit. In particular, the present invention relates to a heat generating unit having a heat generating element formed in a film sheet shape by employing a carbon-based substance as its main component, and to a heating apparatus using the heat generating unit. The heating apparatus according to the present invention includes a variety of appliances that require a heat source, e.g., electronic devices such as a copying machine, a facsimile, a printer and the like, and electric appliances such as an electric space-heating appliance, a cooking appliance, a drying machine and the like.

### BACKGROUND ART

What is widely used among conventional heating apparatuses is a heat generating unit, in which a heat generating element obtained by, for example, adding a resistance value regulating material being a nitride compound and amorphous carbon to a substrate being crystallized carbon such as graphite to prepare a carbon-based substance, and shaping the carbon-based substance in a rod shape or a plate shape (for example, see Japanese Unexamined Patent Publication No. 2001-351762).

As to the heat generating unit, development of a heat source in which a heat generating element is structured with a carbon-based substance is underway. For example, there has been developed a heat generating element whose heat generating property can be adjusted without impairing the flexibility, which is obtained by impregnating the surface of carbon fibers with resin and firing the same to thereby form a carbonized layer (for example, see Japanese Unexamined Patent Publication No. 2001-257058).

A heat generating element woven of such carbon fibers suffers from a problem of smaller resistance value and a lower heat generation temperature as compared with the heat generating element being the carbon-based substance formed in a rod-shape or a plate shape. Additionally, because the heat generating element is woven of the carbon fibers, its resistance value becomes unstable, whereby the heat generation quantity varies among individual products. In an attempt to solve the problems associated with the heat generating element structured with the carbon fibers, heat generating units in a variety of structures have been proposed (for example, see Japanese Unexamined Patent Publication No. 2007-103292).

### CITATION LIST

### Patent Literatures

PLT 1: Japanese Unexamined Patent Publication No. 2001-351762

PLT 2: Japanese Unexamined Patent Publication No. 2001-257058

PLT 3: Japanese Unexamined Patent Publication No. 2007-103292

PLT 4: Japanese Unexamined Patent Publication No. 2005-116412

PLT 5: Japanese Unexamined Patent Publication No. 2005-149809

### SUMMARY OF INVENTION

### Technical Problem

As to the heat generating unit, a variety of measures have been taken to achieve miniaturization and higher heat generation. Japanese Unexamined Patent Publication No. 2007-103292 discloses a heat generating element using carbon fibers in which, in consideration of the low resistance value of the carbon fibers themselves, a band-like heat generating element has its both edge portions cut to form recess portions, to thereby form a narrow current flow path. Thus, a heat source with an increased resistance value that makes it possible to generate heat at high temperatures is provided.

However, in the conventional heat generating unit, though the current path in the heat generating element is narrowed, it suffers from the problem that the resistivity differs among separate sites in the current path, whereby the heat generation temperature varies, and hence the heat distribution in the heat generating element becomes nonuniform. Additionally, the great cut regions formed at the heat generating element for the purpose of narrowing the current path are the factors of deformation, torsion, damage, destruction of the heat generating element.

Accordingly, in the field where the heat generating unit is used as a heat source, development of a heat generating element being miniaturized, capable of generating higher heat and uniformizing the heat distribution, and being highly durable has been desired.

The inventors of the present invention have worked on developing a heat generating unit implementing a novel heat source, by adopting a heat generating element being a novel film sheet-like material as a heat generating material. This film sheet-like material is completely different in material and manufacturing method from the conventionally used sheet-like heat generating element woven of carbon fibers and the conventionally used heat generating element prepared by firing the woven carbon fibers impregnated with resin.

A film sheet raw material being a material of a heat generating element 2 employed in the present invention has a layered structure. The layer surfaces in the planar direction are in various planar shapes, such as flat surfaces, uneven surfaces or wavy surfaces. A space is formed between any opposing layers. In the layered structure of the film sheet raw material, the image of layers having spaces formed in between can be similar to a cross section of a pie, which is obtained by preparing a pie dough carrying out folding works to place half of the dough on top of the other half for a plurality of (for example, some tens or hundreds of) times, and baking such a pie dough. In other words, the heat generating element is a film sheet raw material pliable in the thickness direction, which has an interlayer structure made up of a plurality of layered membrane elements made of a material including a carbon-based substance, the membrane elements being partially bonded to one another in the layered direction.

An object of the present invention is to provide a heat generating unit and a heating apparatus using the above-described novel film sheet-like heat generating element, which is capable of heating a heating target object with a desired heat distribution pattern at high temperatures with high efficiency, and which is miniaturized and has excellent durability.

It is to be noted that, in the present invention, a heating apparatus using a heat generating unit as a heat source includes an image fixing device, and an image forming device provided with the image fixing device. Examples of the image forming device include appliances that require a heat source, such as copying machines, facsimile machines, printer devices, and multifunction peripheral devices provided with the functions of the foregoing devices.

What is used in an image forming process carried out by the image forming device is the image fixing device that pressurizes a recording target member, e.g., a paper, which carries an unfixed toner image, and that heats the resultant at high temperatures to thereby fix the image.

A heat generating unit is used as the heat source of the image fixing device. Examples of the conventional heat generating unit used in the image fixing device are a halogen heater that uses a heat generating element formed with a tungsten material, or a carbon heater that uses an elongated plate-like heat generating element formed with a mixture of crystallized carbon such as graphite, a resistance value regulating material, and an amorphous carbon (see Japanese Unexamined Patent Publication Nos. 2005-116412 and 2005-149809).

The present invention has been made to provide, by use of the heat generating unit achieving the above-described objects, an image fixing device and an image forming device having a heat source that can heat a heating target object with a desired heat distribution at high temperatures with high efficiency in the fixing process, and that starts up quickly, being capable of reducing the energy consumption.

### Solution to Problem

In order to solve the problems associated with the conventional heat generating unit and to achieve the object of the present invention, a heat generating unit according to a first aspect of the present invention includes:

a band-like heat generating element that is formed with a film sheet of a material including a carbon-based substance and that has a two-dimensional isotropic thermal conduction;

a power supply portion supplying electric power to both ends in a longitudinal direction of the heat generating element; and

a container that contains the heat generating element and part of the power supply portion, wherein

the heat generating unit has a plurality of slits each formed at an oblique angle with respect to an axis being parallel to the longitudinal direction of the heat generating element. The heat generating unit of the first aspect structured in this manner implements a heat source that is capable of heating a heating target object with a desired heat distribution pattern at high temperatures with high efficiency, and that has an excellent durability.

In the heat generating unit according to a second aspect of the present invention, the plurality of slits of the heat generating element according to the first aspect include a plurality of first slits extending in parallel from both edge portions opposing to each other along the longitudinal direction of the heat generating element. The heat generating unit of the second aspect structured in this manner implements a heat source that is capable of heating a heating target object with a desired heat distribution pattern at high temperatures with high efficiency, and that has an excellent durability.

In the heat generating unit according to a third aspect of the present invention, the plurality of slits of the heat generating element according to the second aspect include the plurality of first slits, and further include a plurality of second slits arranged at prescribed intervals so as to alternate with the plurality of first slits and to be in parallel to the first slits.

The plurality of second slits are formed at a central portion in a width direction perpendicular to the longitudinal direction of the heat generating element. The heat generating unit according to the third aspect structured in this manner forms a current path at each of edge portions defined between respective both ends of the second slits and respective both edge portions opposing to each other along the longitudinal direction of the heat generating element, thereby achieving a shape expandable in the longitudinal direction of the heat generating element.

In the heat generating unit according to a fourth aspect of the present invention, the first slits and the second slits in the heat generating element according to the third aspect are formed by one of through slots or cuts. The heat generating unit according to the fourth aspect structured in this manner provides a structure that allows the heat generating element to be easily manufactured in a shape expandable in the longitudinal direction of the heat generating element.

In the heat generating unit according to a fifth aspect of the present invention, the heat generating element according to the third aspect is tensely arranged inside the container by the power supply portion, whereby the heat generating element expands in the longitudinal direction of the heat generating element, and a cross section of the heat generating element in the width direction perpendicular to the longitudinal direction of the heat generating element attains a curved shape. The heat generating unit according to the fifth aspect structured in this manner makes it possible to easily set the width of the heating region to be wider or narrower, thereby implementing a heat source capable of heating highly efficiently and being durable.

In the heat generating unit according to a sixth aspect of the present invention, a cross section of the container according to the fifth aspect taken perpendicularly to a longitudinal direction of the container is circular. The heat generating element without being tensely arranged by the power supply member has a width direction dimension longer than an inner diameter of the container, the width direction being perpendicular to the longitudinal direction of the heat generating element. The heat generating unit according to the sixth aspect structured in this manner implements a heat source being miniaturized and capable of heating with high efficiency.

In the heat generating unit according to a seventh aspect of the present invention, the heat generating element according to the first aspect has an interlayer structure formed of the material including the carbon-based substance. The heat generating unit according to a seventh aspect of the present invention structured in this manner implements a highly efficient heat source that can heat a heating target object uniformly and at high temperatures.

In the heat generating unit according to an eighth aspect of the present invention, the container according to the first aspect is structured with one of a heat resistant glass tube and a heat resistant ceramic tube, the container being sealed at the power supply portion, and having its inside filled with an inert gas. The heat generating unit according to the eighth aspect of the present invention structured in this manner implements a highly efficient heat source that can heat at high temperatures.

A heating apparatus according to a ninth aspect of the present invention has installed therein the heat generating unit according to the first to eighth aspects as a heat source, thereby implementing a highly reliable and efficient heating apparatus capable of uniformly heating a heating target object at high temperatures.

An image fixing device according to a tenth aspect of the present invention includes:

a heating element that heats a recording target member carrying an unfixed toner image; and

a pressurizing element that is arranged so as to oppose to the heating element, and that pressurizes against the heating element with the recording target member interposed, wherein

the heating element has a heat generating element as a heat source, the heat generating element being formed to be a band-like film sheet of a material including a carbon-based substance, and the heat generating element having a two-dimensional isotropic thermal conduction. The image fixing device according to the tenth aspect of the present invention structured in this manner starts up quick, and is capable of reducing the energy consumption.

In the image fixing device according to an eleventh aspect of the present invention, the heat generating element according to the tenth aspect has an interlayer structure formed of the material including the carbon-based substance. The image fixing device according to the eleventh aspect of the present invention structured in this manner starts up quickly, being capable of heating a recording target member highly efficiently with a desired heat distribution, which makes it possible to carry out highly reliable image fixing.

In the image fixing device according to a twelfth aspect of the present invention, the heat generating element according to the eleventh aspect has a resistance change rate value falling within a range of 1.2 to 3.5, the resistance change rate value being obtained by dividing a resistance value in a state where lighting equilibrium is reached by energization by a resistance value in a state without energization, the heat generating element having a positive temperature coefficient characteristic in which a heat generating element temperature and a resistance value are proportional to each other. The image fixing device according to the twelfth aspect of the present invention structured in this manner starts up quickly, being capable of heating a recording target member highly efficiently with great accuracy, with a desired heat distribution.

In the image fixing device according to a thirteenth aspect of the present invention, the heat generating element according to the twelfth aspect may be a thin membrane element having a thickness of equal to or smaller than 300 μm. The image fixing device according to the thirteenth aspect of the present invention structured in this manner can carry out fixing with reduced energy consumption, by use of the heat source being smaller in heat capacity and starting up quickly.

In the image fixing device according to a fourteenth aspect of the present invention, the heat generating element according to the twelfth aspect may be a lightweight membrane element having a density of equal to or smaller than 1.0 g/cm³. The image fixing device according to the fourteenth aspect of the present invention structured in this manner can carry out fixing with reduced energy consumption, by use of the heat source being smaller in heat capacity and starting up quickly.

In the image fixing device according to a fifteenth aspect of the present invention, the heat generating element according to the twelfth aspect may be formed of a material having a thermal conductivity of equal to or greater than 200 W/m·K. The image fixing device according to a fifteenth aspect of the present invention structured in this manner is capable of heating with uniform heat distribution, owing to the excellent thermal conductivity of the heat generating element.

In the image fixing device according to a sixteenth aspect of the present invention, the heating element according to the twelfth aspect may include a container that accommodates the heat generating element and part of a power supply portion supplying electric power to opposing both ends of the heat generating element, the container being structured to have its inside filled with an inert gas and to be sealed at the power supply portion. The image fixing device according to the sixteenth aspect of the present invention structured in this manner implements an image fixing device having a highly reliable heat source, thereby becoming possible to heat highly efficiently at high temperatures with a desired heat distribution.

In the image fixing device according to a seventeenth aspect of the present invention, the heating element according to the twelfth aspect is provided with a reflection portion for defining a heating region to be heated by the heat generating element. The image fixing device according to the seventeenth aspect of the present invention structured in this manner is capable of heating the heating region highly efficiently at high temperatures with a desired heat distribution, achieving highly reliable fixing process.

In the image fixing device according to an eighteenth aspect of the present invention, the heating element according to the twelfth aspect may be provided with the heat generating element in a plurality of numbers, respective center axes in the longitudinal direction of the plurality of heat generating elements being arranged on a straight line so as to be perpendicular to a conveying direction of the recording target member. The image fixing device according to the eighteenth aspect of the present invention structured in this manner is capable of switching the heating region depending on the recording target member, whereby it becomes possible to specify highly efficient heating at high temperatures to a desired region.

In the image fixing device according to a nineteenth aspect of the present invention, in the heating element according to the twelfth aspect, a membrane element may be formed with a member that absorbs infrared radiation at a face facing the heat generating element. With the image fixing device according to the nineteenth aspect of the present invention structured in this manner, the heating element absorbs the heat from the heat generating element highly efficiently, whereby it becomes possible to heat the recording target member at high temperatures highly efficiently.

In the image fixing device according to a twentieth aspect of the present invention, a heated range heated by the heat generating element according to the twelfth aspect may include a nip portion serving as a pressed site of the recording target member pressed by the heating element and the pressurizing element, and a site located upstream relative to the nip portion in a conveying direction of the recording target member. The image fixing device according to the twentieth aspect of the present invention structured in this manner is capable of carrying out the image fixing process highly efficiently and surely.

An image forming device according to a twenty-first aspect of the present invention includes the image fixing device according to any one of the first to twentieth aspects. The image forming device according to the twenty-first aspect of the present invention structured in this manner can heat the recording target member being a heating target object at high temperatures with a desired heat distribution. Further, the device starts up quickly, and is capable of exerting heating control with great accuracy while reducing the energy loss.

### ADVANTAGEOUS EFFECTS OF INVENTION

The present invention can provide a miniaturized and durable heat generating unit being capable of heating a heating target object at high temperatures with a desired heat distribution and high efficiency. Further, with the present invention, because the heat generating unit having the above-described effect is installed in a heating apparatus as a heat source, it becomes possible to heat a heating target object with a desired temperature distribution, and to provide a miniaturized, highly efficient, and durable heating apparatus. Still further, with the present invention, it becomes possible to provide an image fixing device and an image forming device having a highly efficient heat source that can heat a recording target member serving as a heating target object at high temperatures with a desired heat distribution. In particular, with the present invention, it becomes possible to provide an image fixing device and an image forming device that start up quickly, and that are capable of carrying out a fixing process with reduced energy consumption.

### BRIEF DESCRIPTION OF DRAWINGS

FIG. 1 is a plan view showing the structure of a heat generating unit according to a first embodiment of the present invention.

FIG. 2 is a front view of the heat generating unit shown in FIG. 1.

FIG. 3 is a plan view of a heat generating element in the heat generating unit according to the first embodiment.

FIG. 4A illustrates that a slit shape of the heat generating element according to the first embodiment allows the heat generating element to be durable.

FIG. 4B illustrates that a slit shape of the heat generating element according to the first embodiment allows the heat generating element to be durable.

FIG. 5 is a front view showing a state in which a tensile force is applied to the heat generating element in the heat generating unit according to the first embodiment.

FIG. 6 is a cross-sectional view illustrating a state where a tensile force is applied to the heat generating element in the heat generating unit according to the first embodiment.

FIG. 7 is a plan view showing a heat generating element in a heat generating unit according to a second embodiment of the present invention.

FIG. 8A is a plan view showing a heat generating element in a heat generating unit according to a third embodiment of the present invention.

FIG. 8B is a plan view showing a heat generating element as a comparative example to the heat generating element in the heat generating unit according to the third embodiment.

FIG. 9 is a perspective view showing an exemplary heating apparatus according to a fourth embodiment of the present invention.

FIG. 10 shows the substantial structure of an image fixing device according to the fifth embodiment of the present invention.

FIG. 11 is a temperature characteristic diagram showing the relationship between temperature [° C.] and resistance [Ω] in a heat generating element in a heat generating unit according to the fifth embodiment.

FIG. 12 is a graph showing the start-up characteristic of each of a heat generating unit used in an image fixing device according to the present invention, and a carbon heater and a halogen heater both serving as conventional heaters.

FIG. 13 shows a comparison among various types of heaters as to an inrush current, where (a) is a current waveform diagram at start-up of a heat generating unit used in an image fixing device according to the present invention; (b) is a current waveform diagram at start-up of a conventional carbon heater; and (c) is a current waveform diagram at start-up of a halogen heater.

FIG. 14 is a graph showing a measurement result of a copper plate temperature obtained by heating a heating target object by a heat generating unit used in an image fixing device according to the present invention and by a conventional heater.

### DESCRIPTION OF EMBODIMENTS

In the following, a description will be given of preferred embodiments of a heat generating unit according to the present invention and a heating apparatus using the heat generating unit with reference to the accompanying drawings.

### First Embodiment

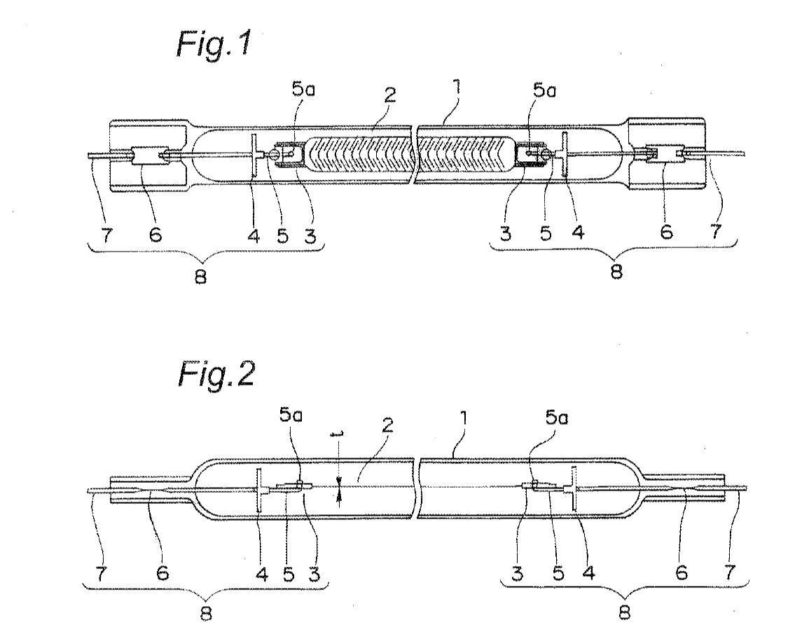

Referring to FIGS. 1 to 6, a description will be given of a heat generating unit according to a first embodiment of the present invention. FIG. 1 is a plan view showing the structure of the heat generating unit according to the first embodiment. Because the heat generating unit has an elongated shape, its intermediate portion is cutaway and omitted in FIG. 1, and both end portions thereof are shown therein. FIG. 2 is a front view of the heat generating unit shown in FIG. 1.

In the heat generating unit according to the first embodiment, a film sheet-like and band-like heat generating element 2 is disposed inside a heat resistant elongated container 1. The band-like heat generating element 2 extends in the longitudinal direction of the container 1. In the heat generating unit according to the first embodiment, the container 1 is formed with a transparent quartz glass tube. Both the end portions of the quartz glass tube are each welded to be a flat plate shape, to thereby structure the container 1. The container accommodating the heat generating element 2 is filled with argon gas as an inert gas. The inert gas with which the container can be filled with is not limited to the argon gas. Other than the argon gas, use of a gas such as the nitrogen gas, or mixture of gases such as the argon gas and the nitrogen gas, the argon gas and a xenon gas, the argon gas and a krypton gas can achieve the effect similar to that achieved by the heat generating unit according to the first embodiment. Accordingly, the inert gas with which the container 1 should be filled can be selected as appropriate in accordance with the intended purpose. The container 1 is filled with the inert gas for the purpose of preventing oxidation of the heat generating element 2 serving as a carbon-based substance in the container, when used under high temperatures. It is to be noted that any heat-resistant, insulating, and heat-transmissive material can be used as the material of the container 1. For example, in addition to the quartz glass, the material can be selected as appropriate out of glass materials such as soda lime glass, borosilicate glass, lead glass and the like, or ceramic materials or the like.

As shown in FIGS. 1 and 2, the heat generating unit according to the first embodiment includes the container 1, the elongated band-like heat generating element 2 as a heat radiation membrane element, and power supply portions 8 respectively provided at both the end portions in the longitudinal direction of the heat generating element 2 for holding the heat generating element 2 at a prescribed position in the container, and for supplying the heat generating element 2 with power.

As shown in FIGS. 1 and 2, the power supply portions 8 provided at both the ends of heat generating element 2 respectively include retainers 3 attached to both the ends of the heat generating element 2, position regulating portions 4 serving as support rings, internal lead wires 5, molybdenum foils 6, and external lead wires 7. To the retainers 3, respective internal lead wires 5 are fixed. The internal lead wires 5 are electrically connected to respective external lead wires 7 that are led to the outside of the container from both the ends of the container 1 through the molybdenum foils 6 embedded in the sealed portion (welded portion) of both the end portions of the container 1.

The heat generating element 2 has its end portions clamped at its plane side and its back side by the retainers 3. Through a through hole formed substantially at the center of each of the retainers 3 and a through hole formed at each end portion of the heat generating element 2, the end portion of the internal lead wire 5 penetrates. Each internal lead wire 5 has its end portion on the heat generating element side bent into what is called an L shape. The tip of each of the internal lead wires 5 bent into an L-shape penetrates through each of the through holes of corresponding retainer 3 clamping the heat generating element 2.

A protruding end portion 5a of each of the internal lead wires 5 protruding from the through hole of corresponding retainer 3 is provided with fall-out preventing means (coming-off preventing means), e.g., a state where it is in a crushed state as having undergone plastic deformation by press working or the like. It is noted that, possible methods of carrying out the plastic deformation to the protruding end portions 5a of the internal lead wires 5 include, in addition to the press working, mechanical processing methods such as rotary swage working and welding methods by use of heat, electric current, plasma and the like. Another possible fall-out preventing means may be a screw-shut method by use of a nut together with threading the protruding end portion 5a of the internal lead wire 5, or an engage-stop method by attaching any retaining ring, e.g., a C-type retaining ring, an E-type retaining ring, to the protruding end portion 5a.

To the internal lead wires 5 respectively connected to both the ends of the heat generating element 2, the position regulating portions 4 having a position regulating function are respectively attached. Each of the internal lead wires 5 is formed with a single wire material, e.g., a molybdenum wire. Each of the position regulating portions 4 is formed with a single wire material, e.g., by forming a molybdenum wire into a coil shape.

While the description proceeds taking up an exemplary case where the position regulating portions 4 and the internal lead wires 5 according to the first embodiment are each formed with a molybdenum wire, they may each be formed using a metal wire (of a round bar shape, of a flat plate shape) made of tungsten, nickel, stainless steel or the like.

The coil-shaped position regulating portions 4 according to the first embodiment are fixed as being respectively wrapped around the internal lead wires 5. The attachment sites in the internal lead wires 5 where the position regulating portions 4 are wrapped around are crushed by press working in the direction where the position regulating portions 4 and the internal lead wires 5 are opposed to each other, and formed such that the fixation is secured by the adhered wrapping.

The coil-shaped position regulating portions 4 wrapped around in an adhered manner the internal lead wires 5 have the position regulating function for disposing the heat generating element 2 at a prescribed position inside the container. The external circumference portion of each position regulating portion 4 is at a position close to the internal circumference face of the container 1. Disposition of the position regulating portions 4 achieves desired positioning of the heat generating element 2 in the longitudinal direction relative to the container 1. In the first embodiment, the center axis being parallel to the longitudinal direction of the heat generating element 2 is disposed substantially on the center axis of the container 1 extending in the longitudinal direction, thereby avoiding contact between the heat generating element 2 and the container 1.

As described in the foregoing, in the heat generating unit according to the first embodiment, the power supply portions 8 structured with the retainers 3, the position regulating portions 4, the internal lead wires 5, the molybdenum foils 6, and the external lead wires 7 tensely arrange the heat generating element 2 in the container at the prescribed position in its longitudinal direction.

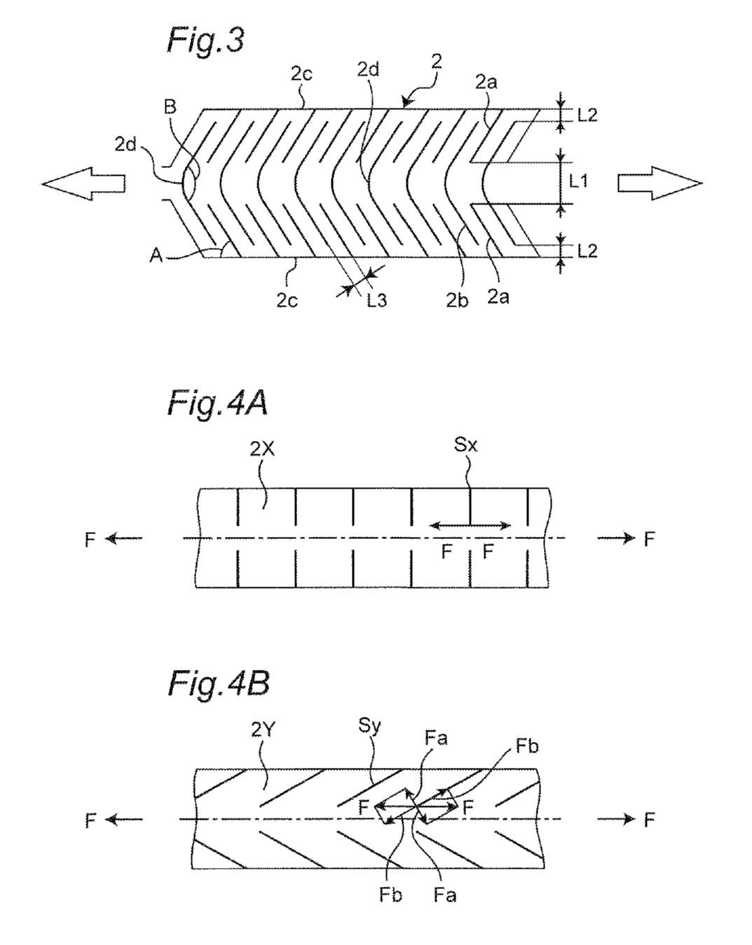

FIG. 3 is a plan view showing the heat generating element 2 in the heat generating unit according to the first embodiment. It is to be noted that, in the heat generating element 2, the face shown in the plan view corresponds to the opposing face to the heating target object.

As shown in FIG. 3, a plurality of slits (first slits 2a and second slits 2b) are formed at the heat generating region of the heat generating element 2 according to the first embodiment. The plurality of slits in the heat generating region are each formed at an oblique angle with respect to an axis being parallel to the longitudinal direction of the heat generating element 2. Out of the slits, the plurality of first slits 2a are formed along both edge portions 2c that are parallel to the longitudinal direction of the heat generating element 2 and that oppose to each other. The plurality of first slits 2a extend diagonally from both the edge portions 2c in a straight manner, and are juxtaposed to one another each at an oblique angle A with respect to corresponding edge portion 2c (see FIG. 3). The first slits 2a diagonally formed from both the edge portions 2c are symmetrically arranged relative to the center axis parallel to the longitudinal direction of the heat generating element 2. The first slits 2a diagonally formed respectively from the opposing edge portions 2c are arranged such that their respective end portions opposing to the others' keep a prescribed distance (L1) between them. As has been described in the foregoing, the first slits 2a are each formed at the oblique angle A with respect to corresponding edge portion 2c. The oblique angle A is preferably equal to or greater than 45° and equal to or smaller than 90°. In particular, about 60° (falling within a range of 55° to 65°) is a preferable angle that provides durability.

FIGS. 4A and 4B illustrate that the slit shape of the heat generating element 2 allows the heat generating element to be durable. FIG. 4A is a plan view showing a mode in which slits Sx being perpendicular to the axis parallel to the longitudinal direction extend from both the edge portions in a heat generating element 2X formed with the same material as the heat generating element 2 according to the first embodiment. FIG. 4B is a plan view showing a mode in which slits Sy being oblique to the axis parallel to the longitudinal direction extend from both the edge portions in a heat generating element 2Y formed with the same material as the heat generating element 2 according to the first embodiment.

When a tensile force F is applied from both the sides of the heat generating element 2X shown in FIG. 4A, the force F is applied as it is to one slit Sx, for example, perpendicularly to the extending direction of the slit Sx. Accordingly, when the tensile force F is applied from both the sides of the heat generating element 2X, the tensile force F is applied as it is to both the sides of the slit Sx. Thus, a state where the slit Sx is pulled by the tensile force F in a direction to be torn apart is established.

On the other hand, when the tensile force F is applied from both the sides of the heat generating element 2Y shown in FIG. 4B, the following forces are applied to one slit Sy, for example. In the slit Sy, the tensile force F is split into a force Fa in a direction perpendicular to the extending direction of the slit Sy and a force Fb in the extending direction of the slit Sy (F=Fa+Fb). Accordingly, when the tensile force F is applied from both the sides of the heat generating element 2Y, the force Fa perpendicular to the extending direction of the slit Sy is applied to both the sides of the slit Sy. The force Fa applied perpendicularly to the extending direction of the slit Sy in the direction to tear apart is smaller than the tensile force F. Thus, in the heat generating element where the slit Sy being oblique to the axis being parallel to the longitudinal direction is formed, as compared with the heat generating element 2X where the slit Sx being perpendicular to the axis parallel to the longitudinal direction is formed, when the tensile force F is applied, the force (Fa) smaller than the tensile force F is applied to both the sides of the slit Sy. Thus, the heat generating element 2Y where the slit Sy is formed withstands the tensile force F, so as to be durable.

As shown in FIG. 3, in the heat generating unit according to the first embodiment, the plurality of first slits 2a extending from the opposing both edge portions 2c of the heat generating element 2, and the plurality of second slits 2b are formed. A plurality of second slits 2b are each formed, similarly to the first slits 2a, at an oblique angle with respect to the axis being parallel to the longitudinal direction of the heat generating element 2.

As shown in FIG. 3, the plurality of second slits 2b are formed at the central portion in the width direction being perpendicular to the longitudinal direction of the heat generating element 2, and are juxtaposed to one another so as to intersect with the center axis being parallel to the longitudinal direction of the heat generating element 2. The second slits 2b are each chevron-shaped, and an apex 2d of the chevron shape is on the center axis parallel to the longitudinal direction of the heat generating element 2. The chevron-shaped second slits 2b are symmetrically formed to the center axis parallel to the longitudinal direction of the heat generating element 2. Accordingly, the apex 2d of the chevron shape is directed to one side in the longitudinal direction of the heat generating element 2 (to the left side in FIG. 3). The second slits 2b are arranged at prescribed intervals alternating with the plurality of first slits 2a juxtaposed along the longitudinal direction. An apex angle B that is an angle of the apex of the second slit 2b is preferably equal to or greater than 90° and smaller than 180°. In particular, about 120° (falling within a range of 115° to 125°) provides a shape of greater curve under the tensile force and, therefore, provides the preferable shape.

It is to be noted that, the shape of the apex portion (the portion including the apex 2d) of each of the second slits 2b in the heat generating unit according to the first embodiment is shaped to form a curve.

The heat generating element 2 structured as described in the foregoing is disposed inside the container with application of the tensile force from both the sides by the power supply portion 8. Therefore, the chevron-shaped portion formed by each second slit 2b is lifted up, whereby the cross section taken perpendicularly to the longitudinal direction of the heat generating element 2 is substantially curved in a chevron shape. Thus, because the heat generating element 2 is provided with the first slits 2a and the second slits 2b, the heat generating element 2 being pulled from both the sides causes the apex 2d of each second slit 2b to be lifted up and to cause the chevron-shaped portion to stand up, thereby establishing a mode where the heat generating element 2 is somewhat expanded in the longitudinal direction. The heat generating element 2 structured in this manner is in a mode where the original state is recovered when the tensile force from both the sides is lost. In other words, the heat generating element 2 has a structure that can expand and contract.

Accordingly, the heat generating unit according to the first embodiment is structured to dispense with an elastic mechanism, e.g., a spring member or the like, for absorbing the thermal expansion and contraction of the heat generating element itself, as for the power supply portions 8 for holding the heat generating element 2. As a result, the heat generating unit according to the first embodiment achieves miniaturization of the structure of the power supply portions 8 for holding the heat generating element 2, which makes it possible to set the heat generating region of the heat generating element 2 to be greater in the container.

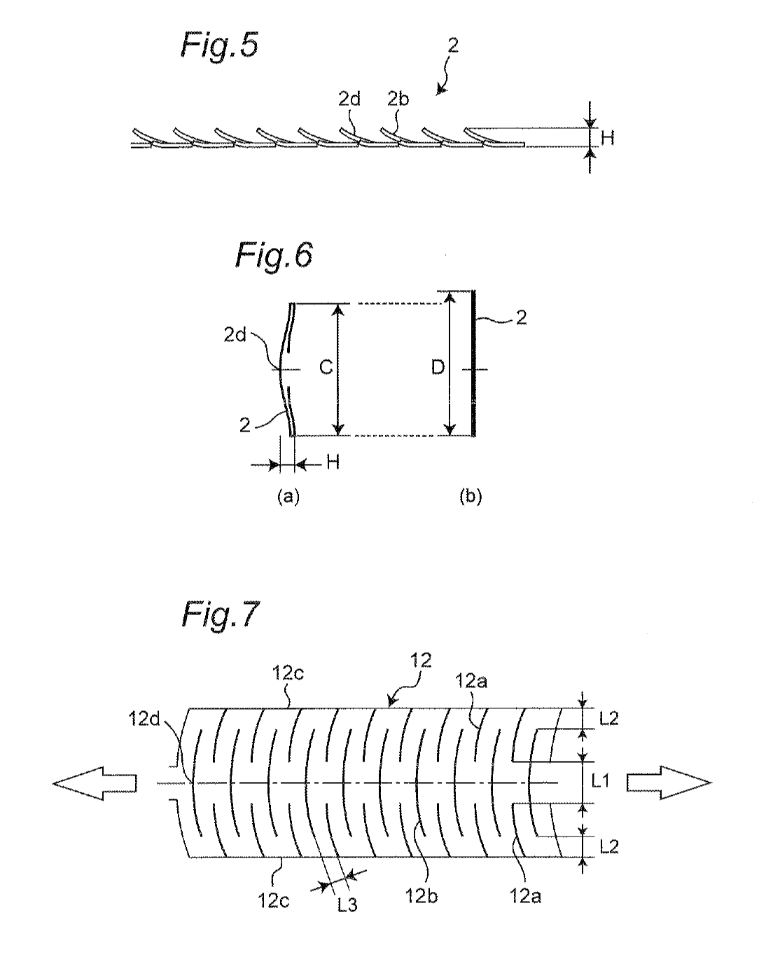

FIG. 5 is a front view showing a state (tensely arranged state) where the tensile force is applied to both the sides of the heat generating element 2. In FIG. 6, (a) is a cross-sectional view taken perpendicularly to the longitudinal direction of the heat generating element 2 in the tensely arranged state where the heat generating element 2 is pulled from both the sides, and (b) is a cross-sectional view taken perpendicularly to the longitudinal direction of the heat generating element 2 when the tensile force applied to the heat generating element 2 is released.

As shown in FIGS. 5 and 6, each apex 2d of the heat generating element 2 with application of the tensile force is lifted up to a height H, so as to have a cross-sectional shape in which the chevron-shaped portion of the heat generating element 2 is curved. Accordingly, the substantial width of the heat generating element 2 in the tensely arranged state as being disposed in the container with application of the tensile force is shorter than the width of the heat generating element 2 in a flat state without application of the tensile force. In FIG. 6, a width C indicates the width of the heat generating element 2 in the tensely arranged state with application of the tensile force, and a width D indicates the width of the heat generating element 2 in a flat state without application of the tensile force. Accordingly, in the heat generating unit according to the first embodiment, because the curved heat generating element 2 is disposed in the tubular container 1 whose cross section is circular, the heat generating element 2 whose width is greater when the tensile force is not applied thereto than the diameter of the container 1 can be accommodated in the container.

Further, because the heat generating element 2 tensely arranged in the container has a curved cross section taken perpendicularly to the longitudinal direction, the heat generating region of the heat generating element 2 attains a curved surface shape. Consequently, by disposing the convex plane portion in the curved surface shape of the heat generating region to face the heating target object, it becomes possible to set the heating region to be wide. Conversely, by disposing the concave plane portion in the curved surface shape of the heat generating region to face the heating target object, it becomes possible to set the heating region to be narrow.

It is to be noted that, when the convex plane portion or the concave plane portion is disposed to face the heating target object as described above, as to the heat radiated from the counter concave plane portion or the convex plane portion, the heating region to the heating target object can be controlled so as to be regulated by use of reflection from a reflection coating or a reflection plate.

As described in the foregoing, in the heat generating element 2 of the heat generating unit according to the first embodiment, the opposing end portions on the center side of the first slits 2a respectively diagonally formed from the opposing edge portions 2c keep a first prescribed distance (the distance indicated by L1 in FIG. 3) between them, so as to form a current path at the central portion of the heat generating element 2. The end portions on the edge portion side being both of the side end portions of the second slit 2b each keep an identical second prescribed distance (the distance indicated by L2 in FIG. 3) from corresponding edge portion 2c of the heat generating element 2, so as to form a current path near the corresponding one of edge portions of the heat generating element 2.

In the heat generating element 2 according to the first embodiment, the first prescribed distance L1 is set to be twice as great as the second prescribed distance L2. The interval (the distance indicated by L3 in FIG. 3) between each first slit 2a and each second slit 2b in the longitudinal direction is as great as the first prescribed distance L2. In the heat generating element 2 where such a slit pattern is formed, a meandering current path is formed, in which the cross-sectional area perpendicular to the same current flow is substantially constant. This facilitates calculation of the resistance value, and achieves uniform temperature distribution. It is to be noted that, with a material having such a characteristic that the thermal conductivity in the planar direction of the heat generating element 2 is, e.g., equal to or greater than 600 W/m·K, the uniform temperature distribution (heat distribution) will not greatly be affected even if the second prescribed distance L2 is not half as great as the first prescribed distance L1. Preferably, by setting the second prescribed distance L2 at least half as great as the first prescribed distance L1, the mechanical strength of the heat generating element against any shock applied to the heat generating unit can be enhanced.

It is to be noted that, while the first slits 2a and the second slits 2b are formed as described above in the heat generating unit according to the first embodiment, the present invention is not limited to such a slit pattern. So long as the slits are each formed at an oblique angle with respect at least to the axis being parallel to the longitudinal direction of the heat generating element 2, a durable current path can be formed, and it becomes possible to provide a heat generating unit capable of heating at high temperatures with high efficiency.

Further, while the description has been given of the mode, in connection with the heat generating unit according to the first embodiment, where the slit pattern is symmetric to the center axis parallel to the longitudinal direction of the heat generating element 2, the present invention is not limited to such a mode. The slit pattern being symmetric to at least a line parallel to the longitudinal direction of the heat generating element 2 will suffice.

Further, by appropriately selecting the shape of the slits formed in the heat generating element 2 according to the specification of the product with which the heat generating unit is used, or the intended use, it becomes possible to implement the temperature distribution (heat distribution pattern) of a desired pattern of the heat generating element 2.

It is to be noted that, in the heat generating unit according to the first embodiment, by designing the intervals L1, L2, and L3 in the longitudinal direction of the first slits 2a and the second slits 2b of the heat generating element 2 to become gradually wider toward both the end portions in the longitudinal direction of the heat generating element 2, it becomes possible to gradually change the resistivity in the current path in the heat generating region, so as to change the temperature distribution (heat distribution pattern) of the heat generating region such that the central portion attains high temperatures. Naturally, by changing the interval L3 according to the specification of the product with which the heat generating unit is used, or the intended use, it becomes possible to implement the heat source having a desired heat distribution pattern.

In the heat generating element 2 according to the first embodiment, the regions leading from the heat generating region to the retained regions held by the retainers 3 have the heat dissipation function. These regions having the heat dissipation function (heat dissipation regions) are provided with no groove such as described in the foregoing, and a wide current path is formed in each of them (see FIG. 1). Consequently, in the heat dissipation regions, the heat transferred from the heat generating region is dissipated, whereby a reduction in thermal stress in the heat generating element 2 and an increase in service life are achieved.

Further, in the heat generating element 2 according to the first embodiment, the retained regions held by the retainer 3 are formed to be narrower than the width of the heat generating region. The edge shape of the heat dissipation regions leading from the retained regions held by the retainer 3 to the heat generating region is formed as a curved surface in order to avoid any damage caused by a concentrated load.

In the heat generating element 2 structured as described above, because the slit pattern having a plurality of slits inhibiting the current flow is formed in the heat generating element 2, it becomes possible to set a desired current path without being restricted by the overall shape of the heat generating element 2. Accordingly, with the heat generating unit according to the first embodiment, it is possible to set a desired heat generation distribution according to the product specification, the intended use or the like. Therefore, it can be used as a versatile heat source.

Because the characteristics of the heat generating element 2 (such as the heat generation temperature, ability to expand and contract, and the like) greatly differ depending on the shape (through slot or cut) and dimension of the slits formed in the heat generating element 2, the shape is determined as appropriate according to the specification of the product with which the heat generating unit is used, the intended use or the like. Additionally, because the characteristics of the heat generating element (such as the heat generation temperature, the change in shape when tensely arranged, ability to expand and contract, and the like) also differ depending on the slit formation method, the slit formation method is likewise selected as appropriate according to the product specification, the intended use or the like.

The heat generating element 2 in the heat generating unit according to the first embodiment is shaped band-like by press working, and provided with a desired slit shape by laser processing. When carrying out the laser processing, if the thermal conductivity in the planar direction of the heat generating element 2 is equal to or greater than 200 W/m·K, there arises a problem that the intended processing cannot be carried out using laser processing which mainly exerts the thermal processing effect, such as a CO₂ laser (wavelength 10600 nm), because the heat generating element 2 deprives the laser of heat. However, by use of laser processing of the wavelengths 1064 to 380 nm which mainly exerts the nonthermal processing effect, for example by use of short wavelength laser processing of a nominal wavelength 1064 nm, a desired shape can be formed with great accuracy.

In particular, the inventors have demonstrated that use of the second harmonic laser processing of a nominal wavelength 532 nm in forming the heat generating element 2 according to the first embodiment achieves processing with great accuracy. The material of the heat generating element 2 according to the first embodiment is a film sheet raw material, i.e., a heat resistant high orientation graphite film sheet obtained by carrying out heat treatment to a high polymer film or a high polymer film with added filler at high temperatures, e.g., in an atmosphere of equal to or higher than 2400° C., and firing the same to graphitize. The heat generating element 2 is formed with a material having such a characteristic that the thermal conductivity in the planar direction is from 600 to 950 W/m·K. When forming the heat generating element 2 using such material, so as to have a thickness (t) of 100 μm, a width (W) of 6.0 mm, and a length (L) of 300 mm, for example, or when providing the heat generating element 2 with a complicated shape such as the slits as described above, it is desirable to employ the second harmonic laser processing of a nominal wavelength 532 nm.

It is to be noted that a thin membrane element whose thickness is equal to or smaller than 300 μm is used as the heat generating element 2 according to the first embodiment.

It goes without saying that a preferable laser processing method can be selected as appropriate in accordance with the material of the heat generating element 2, that is, in accordance with the thermal conductivity in the planar direction and the shape thereof, out of the aforementioned processing methods with laser processing wavelength (1064 to 380 nm) with which the nonthermal processing effect is mainly exerted. Furthermore, it goes without saying that the laser processing method for processing the above-described heat generating element 2 can be employed in processing any heat generating element of a heat generating unit according to other embodiments which will be described later.

The heat generating element 2 used in the heat generating unit according to the first embodiment of the present invention is formed with a film sheet-like material that includes a carbon-based substance as its main component, that has a layered structure in which the layers are partially bonded to one another in the thickness direction such that a space is formed between each of the layers, that exhibits an excellent two-dimensional isotropic thermal conduction, and that has a thermal conductivity of equal to or greater than 200 W/m·K. Accordingly, the band-like heat generating element 2 implements a heat source being free of temperature variations and providing uniform heat generation.

The film sheet raw material, which is the material of the heat generating element 2, is a heat resistant high orientation graphite film sheet obtained by carrying out heat treatment to a high polymer film or a high polymer film with added filler at high temperatures, e.g., in an atmosphere equal to or higher than 2400° C., and firing the same to graphitize, and the material possesses such a characteristic that the thermal conductivity in the planar direction is equal to or greater than 200 W/m·K, ranging from 600 to 950 W/m·K. Thus, the heat generating element 2 used in the first embodiment exhibits the excellent two-dimensional isotropic thermal conduction in which the thermal conductivity in the planar direction ranges from 600 to 950 W/m·K.

As used herein, the two-dimensional isotropic thermal conduction means that the thermal conductivity in every direction on a plane determined by X axis and Y axis perpendicular to each other is substantially the same. Accordingly, in the present invention, the two-dimensional isotropy not only refers to one direction (X axis direction), which is, e.g., the carbon fiber direction in a heat generating element formed by carbon fibers being juxtaposed in the same direction, or two directions (the X axis direction and the Y axis direction), which are the carbon fiber directions in a heat generating element formed by a material woven in a crossing manner of carbon fibers, but it refers to the fact that the film sheet-like heat generating element 2 exhibits an identical property in the planar direction.

A film sheet raw material being a material of a heat generating element 2 employed in the present invention has a layered structure. The layer surfaces in the planar direction are in various planar shapes, such as flat surfaces, uneven surfaces or wavy surfaces. A space is formed between any opposing layers. In the layered structure of the film sheet raw material, the image of layers having spaces formed in between can be similar to a cross section of a pie, which is obtained by preparing a pie dough so as to carry out folding works to place half of the dough on top of the other half for a plurality of (for example, some tens or hundreds of) times, and baking such a pie dough. In other words, the heat generating element 2 is a film sheet raw material pliable in the thickness direction, which has an interlayer structure in which a plurality of membrane elements formed with a material including carbon-based substance are layered, the membrane elements being partially bonded to one another in the layered direction. Accordingly, the film sheet raw material serving as the material of the heat generating element 2 according to the present invention is a material exhibiting the excellent two-dimensional isotropic thermal conductivity whose thermal conductivity in the planar direction is identical as described above.

The high polymer film used as the film sheet raw material manufactured in the manner described in the foregoing may include at least one kind of high polymer film selected from the group consisting of polyoxadiazole, polybenzothiazole, polybenzobisthiazole, polybenzoxazole, polybenzobisoxazole, polypyromellitic imide (pyromellitic imide), polyphenylene isophthalic amide(phenylene isophthalic amide), polyphenylene benzimidazole (phenylene benzimidazole), polyphenylene benzobisimidazole (phenylene benzobisimidazole), polythiazole and polyparaphenylenevinylene. Further, the filler to be added to the high polymer film may include: phosphoric acid ester-based, calcium phosphate-based, polester-based, epoxy-based, stearic acid-based, trimellitic acid-based, metal oxide-based, organic tin-based, lead-based, azo-based, nitroso-based and sulfonyl hydrazide-based compounds. More specifically, examples of phosphoric acid ester-based compounds may include: tricresyl phosphate, (trisisopropylphenyl)phosphate, tributyl phosphate, triethyl phosphate, trisdichloropropyl phosphate and trisbutoxyethyl phosphate. Examples of calcium phosphate-based compounds may include: calcium dihydrogen phosphate, calcium hydrogen phosphorous and calcium triphosphate. Examples of polyester-based compounds may include: a polymer obtained by a reaction between adipic acid, azelaic acid, sebacic acid, phthalic acid or the like, and glycol, glycerins or the like. Further, examples of stearic acid-based compounds may include: dioctyl sebacate, dibutyl sebacate, and acetyltributyl citrate. Examples of metal oxide-based compounds may include: calcium oxide, magnesium oxide and lead oxide. Examples of trimellitic acid-based compounds may include: dibutyl fumarate and diethyl phthalate. Examples of lead-based compounds may include: lead stearate and lead silicate. Examples of azo-based compounds may include: azodicarboxylic amide and azobisisobutylonitrile. Examples of nitroso-based compounds may include: nitrosopentamethylene tetramine. Examples of sulfonyl hydrazide-based compounds may include: p-toluenesulfonyl hydrazide.

By stacking the above-described film sheet raw materials, treating the same in an inert gas at a temperature equal to or greater than 2400° C., and exerting control by adjusting the pressure of the gas treatment atmosphere produced during a process of graphitization, the film sheet-like heat generating element is manufactured. Further, by rolling the film sheet-like heat generating element manufactured in the manner described in the foregoing as necessary, the film sheet-like heat generating element of a further excellent quality can be obtained. The film sheet-like heat generating element manufactured in this manner is used as the heat generating element 2 in the heat generating unit of the present invention.

The appropriate adding amount of the filler falls within a range of 0.2 to 20.0% by weight, and more preferably, within a range of 1.0 to 10.0% by weight. The optimum adding amount differs depending on the thickness of the high polymer. The greater amount of the adding amount is preferable when the high polymer is the thinner, and the smaller amount of adding amount will suffice when the high polymer is thicker. The filler plays a role of establishing a uniformly foamed state of the film having undergone the heat treatment. In other words, the added filler generates gas during heating, which leaves cavities serving as passages that aid in smooth release of the decomposition gas inside the film. In this manner, the filler is helpful for creating the uniformly foamed state.

The film sheet raw material manufactured in the manner described in the foregoing is processed into a desired shape by use of laser processing or the like. Other methods can be employed therefor. For example, it is processed into a desired shape by use of a trimming die such as Thomson die or Pinnacle die, or a sharp-edged tool such as a rotary die cutter.

As described in the foregoing, the heat generating unit according to the first embodiment is a durable heat source that is capable of heating a heating target object with a uniform or a desired heat distribution, to high temperatures with high efficiency. Further, the heat generating unit according to the first embodiment makes it possible to provide a narrowed and miniaturized heat source that achieves quick start-up, and that is capable of realizing a heating region of a desired range.

### Second Embodiment

In the following, a description will be given of a heat generating unit according to a second embodiment of the present invention with reference to FIG. 7. The heat generating unit according to the second embodiment is different from the heat generating unit according to the first embodiment in the slit shape in the slit pattern of the heat generating element, and the rest of the structure is identical to that of the heat generating unit according to the first embodiment described in the foregoing. Therefore, the description of the heat generating unit according to the second embodiment will be given of the slit pattern of the heat generating element. The components possessing the same function and structure as those of the heat generating unit according to the first embodiment are denoted by the same reference characters, and the description given in the first embodiment is applied thereto.

FIG. 7 is a plan view showing part of a heat generating region of a heat generating element 12 in the heat generating unit according to the second embodiment. In the heat generating element 12 shown in FIG. 7, the face shown in the plan view is the opposing face relative to the heating target object.

As shown in FIG. 7, a plurality of arc-shaped slits (first arc-shaped slits 12a and second arc-shaped slits 12b) are formed at the heat generating region of the heat generating element 12 according to the second embodiment. The plurality of first arc-shaped slits 12a are formed with keeping a prescribed distance from one another along both edge portions 12c that oppose to each other and that are in parallel to the longitudinal direction of the heat generating element 2. The plurality of first arc-shaped slits 12a extend from both edge portions 12c to form arc shapes, such that respective center points of the arc shapes are arranged on the center axis that is parallel to the longitudinal direction of the heat generating element 12. A pair of first arc-shaped slits 12a formed respectively from both the edge portions 12c so as to oppose to each other are arranged such that their respective opposing end portions keep a first prescribed distance L1 between them. Accordingly, the pair of first arc-shaped slits 12a formed respectively from both the edge portions 12c are concyclically formed. The plurality of first arc-shaped slits 12a formed along both the edge portions 12c are symmetrically arranged relative to the center axis parallel to the longitudinal direction of the heat generating element 2.

On the other hand, the plurality of second arc-shaped slits 12b intersect with the center axis being the axial center parallel to the longitudinal direction at the central portion in the width direction of the heat generating element 12. The second arc-shaped slits 12b are juxtaposed to one another at regular intervals along the center axis. The arc-shaped second slits 12b are symmetrically arranged relative to the center axis parallel to the longitudinal direction of the heat generating element 2. Accordingly, an apex 12d of the hunched shape formed by each of the second slits 12b is directed to one side in the longitudinal direction of the heat generating element 12. The second arc-shaped slits 12b are arranged at prescribed intervals alternating with the plurality of first arc-shaped slits 12a juxtaposed along the longitudinal direction. The plurality of second arc-shaped slits 12b are substantially in an identical arc shape. The center point of the arc is arranged on the center axis parallel to the longitudinal direction of the heat generating element 12.

As described in the foregoing, in the heat generating element 12 of the heat generating unit according to the second embodiment, respective opposing end portions on the center side of the first arc-shaped slits 12a formed along both the edge portions 12c keep the first prescribed distance L1 between them, so as to form a current path at the central portion of the heat generating element 12. On the other hand, the end portions on the respective edge portion sides serving as both the end portions of the second arc-shaped slit 12b each keeps an identical second prescribed distance L2 from corresponding edge portion 12c of the heat generating element 12. Thus, the second arc-shaped slits 12b form the current path near the both the end portions of the heat generating element 12.

Similarly to the heat generating element 2 according to the first embodiment, in the heat generating element 12 of the heat generating unit according to the second embodiment also, the first arc-shaped slits 12a and the second arc-shaped slits 12b are substantially diagonally formed relative to the edge portions 12c of the heat generating element 12 (i.e., relative to the tensile force direction). Therefore, the heat generating element 12 in the heat generating unit according to the second embodiment achieves a structure that withstands the tensile force so as to be durable.

In the heat generating element 12 according to the second embodiment, the first prescribed distance L1 is set to be twice as great as the second prescribed distance L2. The interval L3 between each first arc-shaped slit 12a and each second arc-shaped slit 12b in the longitudinal direction is as great as the first prescribed distance L2. In the heat generating element 12 where such a slit pattern is formed, a meandering current path is formed, in which the cross-sectional area perpendicular to the same current is substantially constant. This facilitates calculation of the resistance value, and achieves uniform temperature distribution. It is to be noted that, with a material having such a characteristic that the thermal conductivity in the planar direction of the heat generating element 12 is, e.g., equal to or greater than 600 W/m·K, the uniform temperature distribution (heat distribution) will not greatly be affected even if the second prescribed distance L2 is not half as great as the first prescribed distance L1. Preferably, by setting the second prescribed distance L2 to be greater than half the first prescribed distance L1, the mechanical strength of the heat generating element 12 against any shock applied to the heat generating unit can be enhanced.

The heat generating element 12 structured as described in the foregoing is disposed inside the container with application of the tensile force from both the sides by the power supply portions 8 that hold both the ends of the heat generating element 12 to supply the same with power. This causes the apex 12d of the hunched shape formed by each of the second arc-shaped slits 12b to be lifted up, thereby achieving the shape where the cross section taken perpendicularly to the longitudinal direction is substantially hunched.

Accordingly, similarly to the heat generating unit according to the first embodiment, in the heat generating unit according to the second embodiment, because the curved heat generating element 12 is disposed in the tubular container 1 whose cross section is circular, the heat generating element 12 whose width is greater when the tensile force is not applied thereto in proportion to the diameter of the container 1 can be accommodated in the container.

Further, because the heat generating element 12 inside the container has a curved cross section taken perpendicularly to the longitudinal direction, the heat generating region of the heat generating element 12 attains a curved surface shape. Consequently, by disposing the convex plane portion in the curved surface shape of the heat generating region to face the heating target object, it becomes possible to set the heating region to be wide. Conversely, by disposing the concave plane portion in the curved surface shape of the heat generating region to face the heating target object, it becomes possible to set the heating region to be narrow.

It is to be noted that, when the convex plane portion or the concave plane portion is disposed to face the heating target object as described above, as to the heat radiated from the counter concave plane portion or the convex plane portion, the heating region to the heating target object can be controlled so as to be regulated by use of reflection from a reflection coating or a reflection plate.

Further, by appropriately selecting the arc shape or disposition of the arc-shaped slits formed in the heat generating element 12 according to the specification of the product with which the heat generating unit is used, or the intended use, it becomes possible to obtain the temperature distribution (heat distribution pattern) of the heat generating element 12 of a desired pattern.

In the heat generating element 12 in the heat generating unit according to the second embodiment structured as described above, because the slit pattern having a plurality of arc-shaped slits inhibiting the current flow is formed in the heat generating element 12, it becomes possible to set a desired current path without being restricted by the overall shape of the heat generating element 12. Accordingly, with the heat generating unit according to the second embodiment, it is possible to set a desired heat generation distribution according to the product specification and intended use. Therefore, it can be used as a versatile heat source.

As described in the foregoing, the heat generating unit according to the second embodiment is a durable heat source, capable of heating a heating target object with a uniform or a desired heat distribution, to high temperatures with high efficiency. Further, the heat generating unit according to the second embodiment makes it possible to provide a narrowed and miniaturized heat source that achieves quick start-up, and that is capable of realizing a heating region of a desired range.

### Third Embodiment

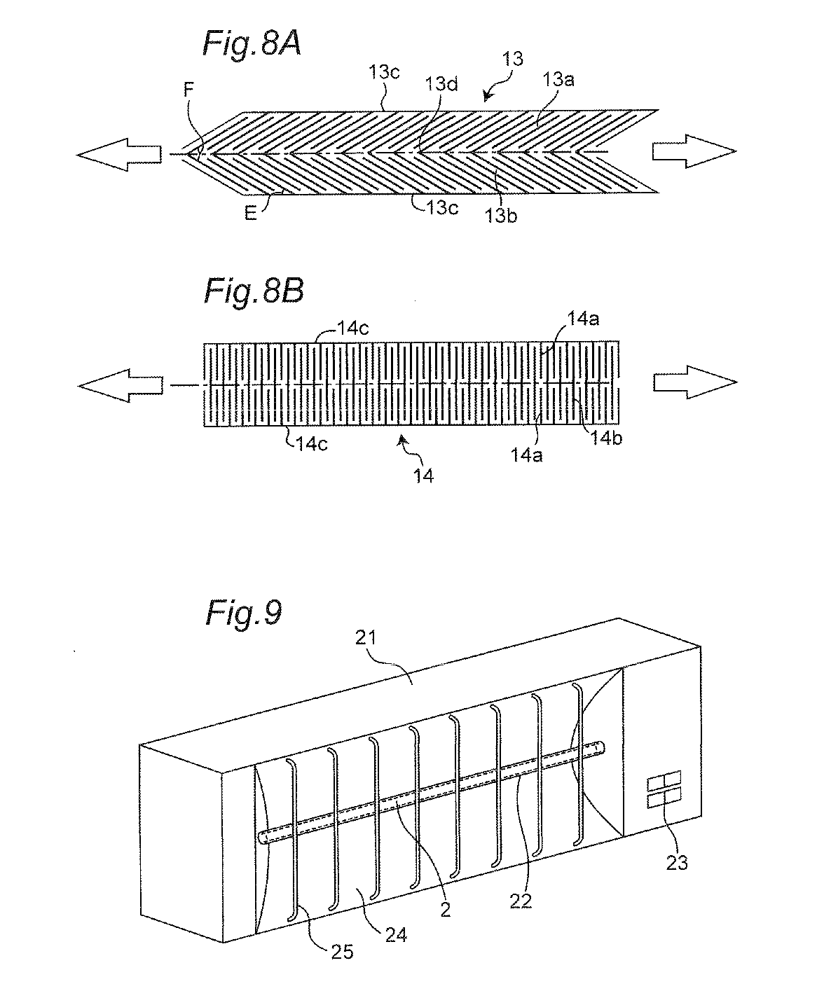

In the following, a description will be given of a heat generating unit according to a third embodiment of the present invention with reference to FIGS. 8A and 8B. The heat generating unit according to the third embodiment is different from the heat generating unit according to the first embodiment in the structure of the slit pattern of the heat generating element, and the rest of the structure is identical to that of the heat generating unit according to the first embodiment described in the foregoing. Therefore, the description of the heat generating unit according to the third embodiment will be given of the structure of the slit pattern of the heat generating element. The components possessing the same function and structure as those of the heat generating unit according to the first embodiment are denoted by the same reference characters, and the description given in the first embodiment is applied thereto.

FIG. 8A is a plan view showing part of a heat generating region of a heat generating element 13 in the heat generating unit according to the third embodiment. In the heat generating element 13 shown in FIG. 8A, the face shown in the plan view is the opposing face relative to the heating target object.

As shown in FIG. 8A, a plurality of slits (first slits 13a and second slits 13b) are formed at the heat generating region of the heat generating element 13 according to the third embodiment. The plurality of first slits 13a are formed along both edge portions 13c that oppose to each other and that are in parallel to the longitudinal direction of the heat generating element 13. The plurality of first slits 13a are formed in a straight manner diagonally from both the edge portions 13c, so as to be juxtaposed to one another each at an oblique angle E with respect to corresponding edge portion 13c. The first slits 13a diagonally formed from both the edge portions 13c are symmetrically arranged relative to the center axis parallel to the longitudinal direction of the heat generating element 13. The first slits 13a diagonally formed respectively from the opposing edge portions 13c are arranged such that their respective end portion opposing to the others' keep a prescribed distance. As shown in FIG. 8A, the first slits 13a are each formed at the oblique angle E with respect to corresponding edge portion 13c. The oblique angle E is preferably equal to or greater than 20° and smaller than 90°. In particular, the oblique angle E being about 30° (falling within a range of 25° to 35°) achieves a preferable shape that is durable and with which a longer current path can be formed.

On the other hand, the plurality of second slits 13b are juxtaposed to one another so as to intersect with the center axis being parallel to the longitudinal direction in the central portion in the width direction of the heat generating element 13. In the heat generating element 13, a chevron-shaped portion whose apex 13d has an acute angle is formed by each of the second slits 13b. The apex 13d of each chevron-shaped portion is directed to one side in the longitudinal direction of the heat generating element 13 (to the left side in FIG. 8A). The second slits 13b are arranged at prescribed intervals alternating with the plurality of first slits 13a juxtaposed along the longitudinal direction. As shown in FIG. 8A, the apex 13d of the chevron-shaped portion formed by the second slit 13b has an apex angle F. The apex angle F is preferably equal to or greater than 50° and smaller than 180°. In particular, the apex angle F being about 60° (falling within a range of 55° to 65°) provides a preferable curved shape when a tensile force is applied, and also provides a preferable shape with which long current path can be formed.

FIG. 8B shows a heat generating element 14 as a comparative example. The slit pattern formed in the heat generating element 14 is structured with slits that are perpendicular to the axis parallel to the longitudinal direction of the heat generating element 14. In the heat generating element 14 shown in FIG. 8B, a plurality of first slits 14a extend in a straight manner perpendicularly to the longitudinal direction from both edge portions 14c. On the other hand, a plurality of second slits 14b intersect with the center axis parallel to the longitudinal direction at the central portion in the width direction perpendicular to the longitudinal direction of the heat generating element 14. The second slits 14b are arranged alternating with the plurality of first slits 14a juxtaposed along the longitudinal direction. When a tensile force is applied to the heat generating element 14 provided with such a slit pattern from its each of both ends, the result is only that the slots of the first slits 14a and the second slits 14b are widened and expanded, and the heat generating element 14 will not obtain a curved shape. Additionally, the heat generating element 14 shown in FIG. 8B is weak in strength against the tensile force exerted so as to pull the same from each of both the sides as described in the foregoing with reference to FIGS. 4A and 4B, and, therefore, the heat generating element 14 may possibly be destroyed.

In contrast thereto, in the heat generating element 13 shown in FIG. 8A, the slit pattern is structured with the slits each at an oblique angle with respect to the axis being parallel to the longitudinal direction. This makes it possible to form a narrow and long current path. In addition thereto, this allows the apex 13d of each chevron-shaped portion to be lifted up and the heat generating element 13 to obtain a curved shape when being tensely arranged inside the container, to achieve a mode where expansion and contraction is possible. Further, the heat generating element 13 shown in FIG. 8A is great in strength against the tensile force exerted to pull the heat generating element 13 from each of both the sides thereof, and is durable, while being able to be assembled easily. Hence, the heat generating element 13 implements a heat source that is highly reliable.

In the heat generating element 13 in the heat generating unit according to the third embodiment structured as described above, because the slit pattern having a plurality of slits inhibiting the current flow is formed, it becomes possible to set a desired current path without being restricted by the overall shape of the heat generating element 13. Accordingly, with the heat generating unit according to the third embodiment, it is possible to set a desired heat generation distribution according to the product specification and intended use. Therefore, it can be used as a versatile heat source.

In the foregoing, the description has been given of a variety of slits according to the first to third embodiments of the present invention. It is to be noted that the term oblique angle as used in the present invention refers to every angle that is not parallel to both the edges being parallel to the longitudinal direction of the heat generating element, nor the right angle relative thereto, and the oblique angle is not limited to the one formed by a straight line. For example, in the first embodiment, as shown in FIG. 3, the straight slits 2a are formed at the oblique angle A with respect to both the edge portions 2c of the heat generating element 2. Further, in the second embodiment, as shown in FIG. 7, the arc-shaped slits 12a are formed at both the edge portions 12c of the heat generating element 12. In this case, the oblique angle is defined as an angle formed between the tangent of each arc-shaped slit 12a and corresponding edge portion 12c. In the third embodiment, as shown in FIG. 8A, the straight slits 13a are each formed at the oblique angle E with respect to each of both the edge portions 13c of the heat generating element 13. Thus, the term oblique angle as used in the present invention refers to every angle that is not parallel to both the edges being parallel to the longitudinal direction of the heat generating elements 2, 12, and 13, nor the right angle relative thereto. It goes without saying that the slit shape in the present invention can achieve the effect of the present invention in whichever combination of the following, i.e., any combination of straight lines, or any combination of a straight line and a curved line.

The description has been given of the embodiments in which the slits are diagonal relative to the edge portions extending in the longitudinal direction of the heat generating element on the precondition that the heat generating element is pulled in its longitudinal direction. Here, it goes without saying that, so long as the slits are diagonal relative to the direction of the tensile force, the structure in which the durability of the heat generating element is secured can be obtained.

### Fourth Embodiment

In the following, a description will be given of a heating apparatus according to a fourth embodiment of the present invention with reference to FIG. 9.

FIG. 9 is a perspective view showing an exemplary heating apparatus having installed therein the heat generating unit described in the first to third embodiments.

The heating apparatus shown in FIG. 9 shows a space-heating appliance 21 as an exemplary heating apparatus of the present invention. Inside the heating appliance 21, the heat generating unit of the present invention described in the first to third embodiments is installed. It is to be noted that, in the fourth embodiment, the heat generating unit is denoted by the reference character 22 for the purpose of description. The heating appliance 21 of the fourth embodiment is provided with constituents used in a general space-heating appliance, such as a temperature controller 23, a reflection plate 24, a protecting cover 25 and the like.

In the heating appliance 21 structured as above, by applying a rated voltage to the heat generating unit 22, a prescribed current flows through the heat generating element 2 in the heat generating unit 22 to generate heat, and the temperature rises with quick start-up. The heating appliance 21 according to the fourth embodiment is surely kept at a prescribed temperature desired by the user under the temperature control exerted by the temperature controller 23. As to the heat generating unit 22, a band-like heat generating element 2 having a plane is used as a heat source. Accordingly, the heat radiated from the plane has directivity. In the heating appliance 21 according to the fourth embodiment, the plane portion of the heat generating element 2 of the heat generating unit 22 is arranged to face the front side and the back side. Therefore, the heat radiated from the front side of the generating element 2 heats the heating target region on the front side of the heating appliance 21, and the heat radiated from the back side of the heat generating element 2 is reflected off the reflection plate 24 to heat the heating target region. It is to be noted that, because the heat generating element 2 is formed band-like with the film sheet raw material, the heat quantity radiated sideways from the heat generating element 2 is very small, being small enough to be negligible as compared with the heat quantity radiated from the front side (back side). Accordingly, the heating appliance 21 according to the fourth embodiment possesses high directivity, and is capable of heating the heating target region highly efficiently.

The heat generating unit 22 installed in the heating apparatus of the present invention has the heat generating unit 2 described in the first to third embodiments. The heat generating element 2 is formed with the film sheet raw material possessing an excellent two-dimensional isotropic thermal conduction in which the thermal conductivity in the planar direction is substantially the same, and has such a characteristic that, owing to its small heat capacity, it starts up quickly, and suffers from a small amount of inrush current. Accordingly, the heating appliance having installed therein the heat generating unit of the present invention as a heat source can implement a space-heating appliance that has an excellent characteristic of good response that realizes quick heating, and of being capable of heating a prescribed region with high efficiency.

It is to be noted that, the heat generating unit of the present invention can be used as a heat source of a great variety of electronic/electric appliances being not limited to the space-heating appliance. For example, it can be used for a variety of appliances such as OA appliances having installed therein a high-temperature heat generating element, such as a copying machine, a facsimile, and a printer, or electric appliances that require a heat source, such as a cooking appliance, a drying machine, and a humidifier.

### Fifth Embodiment

Next, a description will be given of preferred embodiments of an image fixing device according to the present invention and an image forming device using the image fixing device with reference to the accompanying drawings. The image fixing device and the image forming device described herein have the heat generating unit described in the first to third embodiments installed therein as a heat source.

As described in the foregoing, the inventors of the present invention have adopted a novel film sheet-like material (film sheet raw material) as a heat generating material for the heat generating element, which is completely different in material and manufacturing method from the heat generating element used in the conventional image fixing device. The film sheet-like material (film sheet raw material) to be adopted to a heat generating element used in a heat generating unit implementing a novel heat source of the image fixing device achieves high temperatures with high efficiency, being smaller in heat capacity owing to its being lightweight and thin, and having an excellent start-up characteristic.

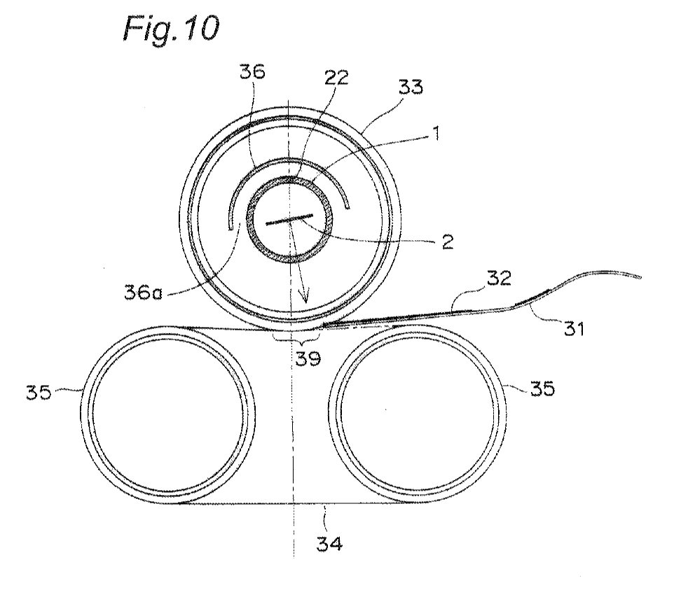

A description will be given of the image fixing device according to the fifth embodiment using the heat generating unit of the present invention with reference to FIGS. 10 to 14.

In an image forming process carried out by the image forming device, on the surface of a photosensitive drum uniformly charged by a charging device, an electrostatic latent image specified by an exposure device is formed, and in accordance with the electrostatic latent image, a toner image is formed by a developing device. The toner image formed on the surface of the photosensitive drum is transferred on a recording target member such as a paper conveyed by a transfer device. The recording target member, e.g., a paper, carrying thereon the unfixed toner image transferred in this manner, is conveyed to an image fixing device that fixes the image. The image fixing device pressurizes and heats the recording target member carrying the unfixed toner image, to thereby fix the unfixed toner image on the recording target member.

It is to be noted that, as to the image forming device according to the fifth embodiment, a description will be given of an image forming process of a single-color image. In a case where an image forming process of a multicolor image is carried out, the present invention is structured such that four sets of the above-described photosensitive drums are juxtaposed to one another so as to correspond to color toners of four colors. Then, toner images of respective colors are sequentially transferred to the transfer belt, and a multicolor image is gradually transferred on the recording target member. In this manner, the multicolor image transferred on the recording target member is pressurized and heated by the image fixing device so as to be fixed.

FIG. 10 shows the substantial structure of the image fixing device according to the fifth embodiment. As described in the foregoing, in the image forming process, the image fixing device pressurizes the recording target member carrying the unfixed toner image and heats the same at high temperatures, thereby melting the unfixed toner image so as to be fixed on the recording target member.

In FIG. 10, the image fixing device according to the fifth embodiment includes: a fixing roller 33 serving as a heating element that heats an unfixed toner image 32 carried on a recording target member 31 to melt the same; a pressure belt 34 that pressurizes the recording target member 31 carrying the unfixed toner image 32 by pressing the same against the fixing roller 33, and that fixes by use of the pressure the unfixed toner image 32 to the recording target member 31; and two pressure rollers 35 and 35 that rotate the pressure belt 34 so as to press the same against the fixing roller 33 with a desired force. In the image fixing device according to the fifth embodiment, the pressurizing element is structured with the pressure belt 34 and the pressure rollers 35 and 35.

It is to be noted that, while the image fixing device according to the fifth embodiment is structured to convey the recording target member 31 by the pressure belt 34 to a nip portion 39 serving as the fixing region, to achieve fixation by use of pressure, it is also possible to structure the image fixing device according to the fifth embodiment such that the pressure rollers 35 and 35 disposed to face the fixing roller 33 pressurize the recording target member 31 by pressing the recording target member 31 against the fixing roller 33. Further, the description of the image fixing device according to the fifth embodiment proceeds taking up an exemplary case where the heating element is structured with the fixing roller 33, it is also possible to structure the heating element with a belt rotated by rollers.

As shown in FIG. 10, inside the fixing roller 33, the heat generating unit 22 having the heat generating element 2 is provided. In the heat generating unit 22, the heat generating element 2 is a heat source for heating the fixing roller 33, and the heat generating element 2 is enclosed inside the container 1. Around the elongated container 1 enclosing the heat generating element 2 therein, a tubular reflection portion 36 having an opening is disposed. The reflection portion 36 is made of stainless steel, and has its internal surface mirror-finished. The opening 36a formed at the reflection portion 36 extends in parallel to the longitudinal direction of the heat generating element 2. The opening 36a of the reflection portion 36 is an emission aperture for emitting the heat radiated from the heat generating element 2 together with the heat reflected off the internal surface of the reflection portion 36 toward the nip portion 39 of the fixing region implemented by the fixing roller 33 and the pressure belt 34. In the image fixing device according to the fifth embodiment, the opening 36a of the reflection portion 36 is directed such that the region heated by the heat generating unit 22 is located on the most upstream side in the conveying direction of the recording target member 31 in the nip portion 39. Further, the plane side of the band-like heat generating element 2 of the heat generating unit 22 is also directed to the most upstream side in the conveying direction of the recording target member 31 in the nip portion 39.

While the description of the image fixing device according to the fifth embodiment proceeds taking up the structure in which the reflection portion 36 is disposed around the heat generating unit 22, the image fixing device of the present invention can be implemented with a structure in which the reflection portion is dispensed with, and the heat generating unit 22 heats the surrounding fixing roller 33.

In the image fixing device according to the fifth embodiment, the fixing roller 33 is structured with a plurality of layers such that the heat radiated from the heat generating unit 22 is absorbed by the fixing roller 33 highly efficiently and such that the heat is retained therein. The internal surface of the fixing roller 33 is provided with an infrared absorption layer that absorbs and not reflects the heat (infrared radiation) from the heat generating unit 22.

While the description of the image fixing device according to the fifth embodiment proceeds taking up the exemplary case where a single heat generating unit 22 is provided, the heat generating unit 22 may be provided in a plurality of numbers. When a plurality of heat generating units 22 are provided, respective center axes in the longitudinal direction of the heat generating units 22 are arranged on a straight line so as to be perpendicular to the conveying direction of the recording target member 31. The image fixing device having a plurality of heat generating units 22 installed inside the fixing roller 33 implements a structure that permits selection of the heat generating unit 22 to be supplied with power, in accordance with the size of the recording target member 31. Because the heat generating element 2 of the heat generating unit 22 used in the image fixing device of the present invention is a film sheet-like band element, the heat radiation amount from its plane portion is extremely greater than the heat radiation amount from its sideway face portion, whereby high directivity is exhibited. Accordingly, in the image fixing device provided with a plurality of heat generating units 22, it becomes possible to set the region that is heated in an overlapping manner by adjacent heat generating units 22 to be reduced in size. Thus, it becomes possible to heat around the nip portion uniformly with high efficiency.

Further, in the image fixing device according to the fifth embodiment, irrespective of the number of the installed heat generating unit(s) 22 being singular or plural, because the film sheet-like heat generating element 2 used in the heat generating unit 22 exhibits high directivity and has an excellent start-up characteristic as will be described later, it becomes possible to carry out the image fixing process in the image forming process with high efficiency and at high speeds.

As to the structure of the heat generating unit 22 of the image fixing device according to the fifth embodiment, because the heat generating unit described in the first to third embodiments is used therefor, the detailed description thereof is not repeated herein.

In the following, a description will be given of the characteristic of the heat generating element 2 of the heat generating unit 22 used as a heat source in the image fixing device according to the fifth embodiment of the present invention in comparison with the conventional ones.

First, a heat source having been used in a conventional image fixing device will be described.

A halogen heater having been used as a heat source in a conventional image fixing device is advantageous in that it starts up quickly when power is turned on. On the other hand, the halogen heater has been suffering from the following problems: a great inrush current occurs in the halogen heater, which necessitates a large-capacity control circuit in order to control turn on/off operation of the halogen heater; which in turn invites an increase in size, and becomes disadvantageous also from a cost-effectiveness standpoint. Further, the halogen heater is associated with a problem that the control exerted over the halogen heater causes a fluorescent lamp, which is a nearby lighting device, to flicker (flicker phenomenon).

A carbon heater suffers little from an inrush current. Therefore, the problems such as a reduction in voltage when power to the heat generating element is turned on, and the flicker of a fluorescent lamp (flicker phenomenon), are alleviated. However, the carbon heater takes time to start up, and to carry out the fixing process in the image forming process. Therefore, it is associated with a problem of an increase in energy consumption when carrying out the fixing process.

On the other hand, in a carbon heater using a plate-like heat generating element formed with a mixture of crystallized carbon such as graphite, a resistance value regulating material, and amorphous carbon, the carbon-based substance has high infrared emissivity of 78 to 84%. Accordingly, use of the carbon-based substance as a heat generating element brings about an increase in the infrared emissivity from the carbon heater, whereby it becomes possible to structure a highly efficient heat source. However, the heat generating element used as the carbon heater is a plate-like heat generating element having a thickness (for example, some mm), having a considerable heat capacity. Thus, it is associated with a problem that it takes time to start up when power is turned on.

The heat generating element having been used as the carbon heater has such a temperature-resistance characteristic that the resistance value is substantially constant irrespective of the temperature of its heat generating element, and the inrush current occurs rarely. Thus, because the inrush current occurs rarely in the heat generating element having been used as the conventional carbon heater, the problems such as a reduction in voltage when power to the heat generating element is turned on and the flicker of a fluorescent lamp (flicker phenomenon) are alleviated. However, use of the heat generating element as a heat source is associated with the following problems: it takes time to start up as well as to carry out the fixing process in the image forming process, an increase in energy consumption when carrying out the fixing process occurs.

The inventors have conducted a comparative experiment in the temperature characteristic, which is the relationship between temperature [° C.] and resistance [Ω], by structuring 100V- and 600 W-specification heaters for each of the following: the heat generating element 2 of the heat generating unit 22 used in the image fixing device according to the fifth embodiment of the present invention; the heater using the elongated plate-like heat generating element whose main component is the carbon-based substance, which has been used as the heat source in the conventional image fixing device (hereinafter, referred to as the carbon heater for short); and a heater using a halogen lamp (hereinafter, referred to as the halogen heater for short) as a reference example.

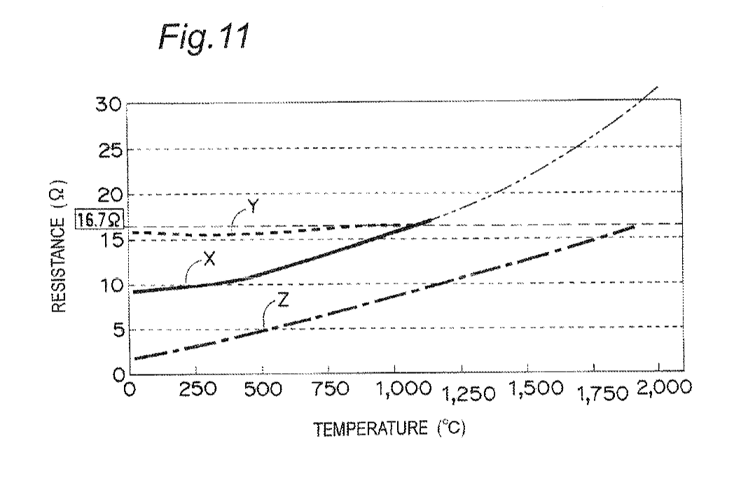

It is to be noted that the heat generating unit 22 used in the following experiment (the experiment of which result is shown in FIGS. 11 to 14) is a heat generating unit similarly structured as the heat generating unit (see FIGS. 1 and 2) described in the first embodiment.

FIG. 11 is a temperature characteristic diagram showing the relationship between temperature [° C.] and resistance [Ω] as to each of the heat generating element 2 of the heat generating unit 22, the carbon heater being the conventional heat source, and the halogen heater. In FIG. 11, the solid line X represents the temperature characteristic of the heat generating element 2 of the heat generating unit 22 used in the image fixing device according to the present invention. Similarly, in FIG. 11, the broken line Y represents the temperature characteristic of the carbon heater, and the alternate long and short dash line Z represents the temperature characteristic of the halogen heater as the reference example.

As shown in FIG. 11, the heat generating element 2 of the heat generating unit 22 used in the image fixing device according to the fifth embodiment of the present invention has the positive temperature coefficient characteristic in which the higher the temperature becomes, the greater the resistance becomes. According to the experiment, for example, when the temperature of the heat generating element 2 was 20° C. (when not energized), the resistance value was 9.2Ω; when the temperature where lighting equilibrium was reached was 1120° C., the resistance value was 16.7Ω. Accordingly, the rate of change of the resistance value (resistance change rate) of the heat generating element 2 between the state where not being energized and the state where lighting equilibrium is reached is 1.81. It is to be noted that, as used herein, the state where lighting equilibrium is reached refers to a state where the heat generation temperature of the heat generating element becomes constant, which is established after a voltage (of 100 V, for example) is applied to the heater and power is supplied thereto, allowing the current to flow through the heat generating element. Further, the resistance change rate refers to a value obtained by dividing a resistance value of the heat generating element 2 when lighting equilibrium is reached by energization by a resistance value without energization.

On the other hand, the temperature characteristic of the carbon heater serving as the conventional heat generating element represented by the broken line Y shows substantially constant resistance value despite changes in temperature. According to the experiment of the inventors, when the temperature of the carbon heater was 20° C. (without energization), the resistance value was 15.9Ω; when the temperature where lighting equilibrium was reached was 1030° C., the resistance value was 16.7Ω. Accordingly, the resistance change rate of the carbon heater between the state without energization and when lighting equilibrium is reached is 1.05. Further, as to the halogen heater represented by the alternate long and short dash line Z, when the temperature was 20° C. (without energization), the resistance value was 1.8Ω; when the temperature where lighting equilibrium was reached was 1830° C., the resistance value was 16.7Ω. Accordingly, the resistance change rate of the halogen heater between the state without energization and when lighting equilibrium is reached is 9.28.

It is to be noted that, in a case where the heat generating element 2 used in the image fixing device according to the fifth embodiment was used to supply power such that the temperature when lighting equilibrium was reached became 500° C. also, the start-up characteristic represented by the solid line X in FIG. 11 was exhibited, and the resistance value at 500° C. was 11.0Ω. Accordingly, the resistance change rate of the heat generating element 2 between the state without energization and the state where lighting equilibrium is reached is 1.2 (=11.0/9.2).

In a case where the heat generating element 2 used in the image fixing device according to the fifth embodiment was used to supply power such that the temperature when lighting equilibrium was reached became 2000° C., the start-up characteristic represented by the alternate long and two short dashes line following the solid line X in FIG. 11 was exhibited, and the resistance value at 2000° C. was 32.2Ω. Accordingly, the resistance change rate of the heat generating element 2 between the state without energization and the state where lighting equilibrium is reached is 3.5 (=32.2/9.2).

As described in the foregoing, the heat generating element 2 of the heat generating unit 22 used in the image fixing device according to the fifth embodiment has the positive temperature coefficient characteristic in which the higher the temperature becomes, the greater the resistance becomes. For example, when the temperature where lighting equilibrium was reached was set to 500° C., the resistance value when lighting equilibrium was reached was 11.0Ω, and the resistance change rate was 1.2. When the temperature where lighting equilibrium was reached was set to 2000° C., the resistance value when lighting equilibrium was reached was 32.2Ω, and the resistance change rate was 3.5. Thus, the characteristic where the temperature and the resistance value are substantially proportional to each other is exhibited.

Further, the heat generating element 2 of the heat generating unit 22 used in the image fixing device according to the fifth embodiment provided the resistance change rate of 1.81, which was obtained by dividing the resistance value when lighting equilibrium was reached with energization of rated power by the resistance value without energization. Thus, the heat generating element 2 of the heat generating unit 22 used in the image fixing device of the present invention has a certain resistance (9.2Ω) even when not being energized, and has the resistance change rate between the state without energization and the state where lighting equilibrium is reached is 1.81.

By setting the electric power or the heater temperature such that the resistance change rate falls within a range of 1.2 to 3.5, the heat generating element 2 of the heat generating unit 22 of the present invention exerts the effect of being capable of generating heat at a desired temperature with great accuracy, and achieving quicker start-up when generating heat when the heat generating unit 22 is lit, without inviting occurrence of a great inrush current. It is to be noted that, when the resistance change rate between the state without energization and the state where lighting equilibrium is reached falls within a range of 1.2 to 3.5, the start-up when generating heat becomes quicker and, as will be described later, the appliance for controlling the heat generating unit 22 is not required to be of a large capacity. If a heat generating element whose resistance change rate is smaller than 1.2 is used, then what is obtained is an image fixing device whose temperature is low, with a small inrush current and sluggish start-up. On the other hand, if a heat generating element whose resistance change rate exceeds 3.5 is used, then it becomes necessary to provide greater room for each of the constituents for securing reliability, because a great inrush current occurs. This poses a problem of an increase in the volume of the constituents, which eventually incurs an increase in both the manufacturing cost and the size of the device.

On the other hand, when the carbon heater is used as the heat source, because its resistance value is substantially constant irrespective of the temperature, when being lit, no inrush current occurs and a substantially constant current flows through. Accordingly, use of the carbon heater as the heat source poses a problem that the rising speed (start-up) of heat generation temperature is sluggish, and it takes time until a prescribed temperature is reached. Consequently, when it is used as the heat source of the image fixing device, there arises a problem that it takes time until the nip portion reaches a desired temperature, taking time to carry out the image fixing process as well as to start up quickly.

The specific resistance value of the heat generating element 2 of the heat generating unit 22 is 250 μΩ·cm; the specific resistance value of carbon of the carbon heater is 3000 to 50000 μΩ·cm; and the specific resistance value of tungsten of the halogen heater is 5.6 μΩ·cm. As stated above, the specific resistance value of carbon is extremely higher than the materials of the other heaters. This realizes the design with small current variations and with little occurrence of the inrush current when power is turned on. Further, while the specific resistance value of the heat generating element 2 is smaller than the specific resistance value of carbon, it is greater than the specific resistance value of tungsten. This makes it possible to design the heat generating element 2 easier as compared with the heat generating element of tungsten.

Further, the density of the heat generating element 2 of the heat generating unit 22 is 0.5 to 1.0 g/m³ (subjected to vary depending on the thickness); the density of carbon of the carbon heater is 1.5 g/m³; and the density of tungsten of the halogen heater is 19.3 g/m³. Thus, because the density of the heat generating element 2 is lower than the materials of the other heaters, and the heat generating element 2 is a band-like thin membrane element, it can be understood that its heat capacity is extremely smaller than those of the other heaters, and it starts up quicker.

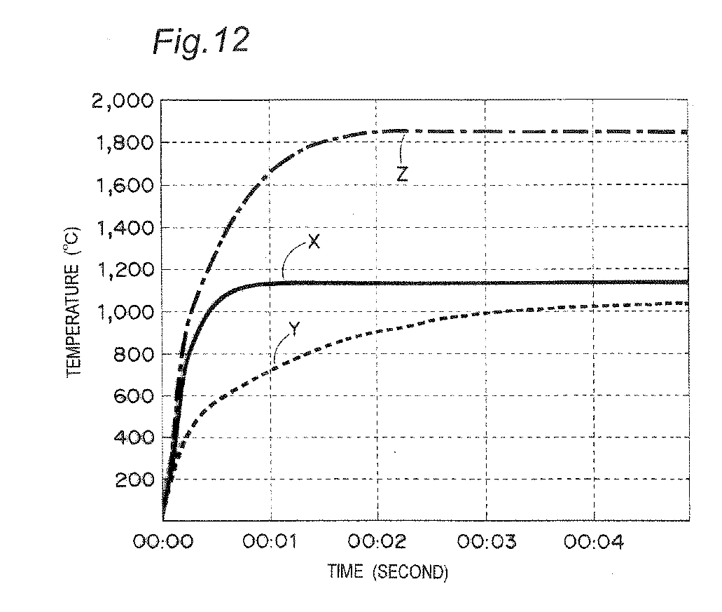

FIG. 12 is a graph showing an examination result of the start-up characteristic as to each of the heat generating unit 22 used in the image fixing device of the present invention, and the carbon heater and the halogen heater both serving as the conventional heaters.

In FIG. 12, the solid line X represents the start-up characteristic of the heat generating unit 22 used in the image fixing device of the present invention. In FIG. 12, the broken line Y represents the start-up characteristic of the carbon heater using the aforementioned elongated plate-like heat generating element whose main component is the carbon-based substance, and the alternate long and short dash line Z represents the start-up characteristic of the halogen heater using the halogen lamp. In the characteristic diagram shown in FIG. 12, using the heaters structured in accordance with the 100V- and 600 W-specification, the start-up characteristics from lighting up until after a lapse of 5 seconds are shown.

As can be seen from respective start-up characteristics shown in FIG. 12, the start-up characteristic of the heat generating unit 22 used in the image fixing device of the present invention (the solid line X in FIG. 12) shows quicker start-up as compared with the start-up characteristic of the carbon heater serving as the conventional heat source (the broken line Y in FIG. 12). According to the experiment of the inventors, the time it took to reach the temperature 90% as great as the temperature when lighting equilibrium was reached was 0.6 seconds for the heat generating unit 22, whereas it was 2.7 seconds for the carbon heater. The time it took to reach the temperature 90% as great as great as the temperature when lighting equilibrium was reached was 1.1 seconds for the halogen heater.

As described above, because the start-up time until when lighting equilibrium is reached differs among the heaters, i.e., the heat generating unit 22, the carbon heater, and the halogen heater, the power consumption at the start-up time will greatly differ among them. For example, while there is a current variation upon activation in each heater used in the experiment described above, assuming that 6 A is consumed, the time it took to reach the temperature 90% as great as the temperature when lighting equilibrium was reached was 0.6 seconds for the heat generating unit 22 and, therefore, the power consumption during that time is about 360 W·S. On the other hand, the time it took to reach the temperature 90% as great as the temperature when lighting equilibrium was reached was 2.7 seconds for the carbon heater and, therefore, the power consumption during that time is about 1620 W·S. Further, the time it took to reach the temperature 90% as great as the temperature when lighting equilibrium was reached was 1.1 seconds for the halogen heater and, therefore, the power consumption during that time is about 600 W·S.

Thus, the power consumption until when lighting equilibrium is reached in the heat generating unit 22 is drastically smaller than those of the other heaters. Because the fixing process is frequently performed in the image fixing device and the turn-on and turn-off operations are repeatedly performed, this difference becomes extremely great. Hence, the energy consumption is drastically reduced.

It is to be noted that, the halogen heater exhibits the relatively short reaching time because its resistance value without energization is low and a great inrush current occurs at the initial power-on, as shown in FIG. 11. The foregoing calculation of the power consumption of the halogen heater is based on the assumption that 6 A is consumed. However, practically, during a period between 0 to 5 seconds at the initial turn-on of the halogen heater until stabilized, a great inrush current flows through. Accordingly, the power consumption during that period becomes a further greater value.

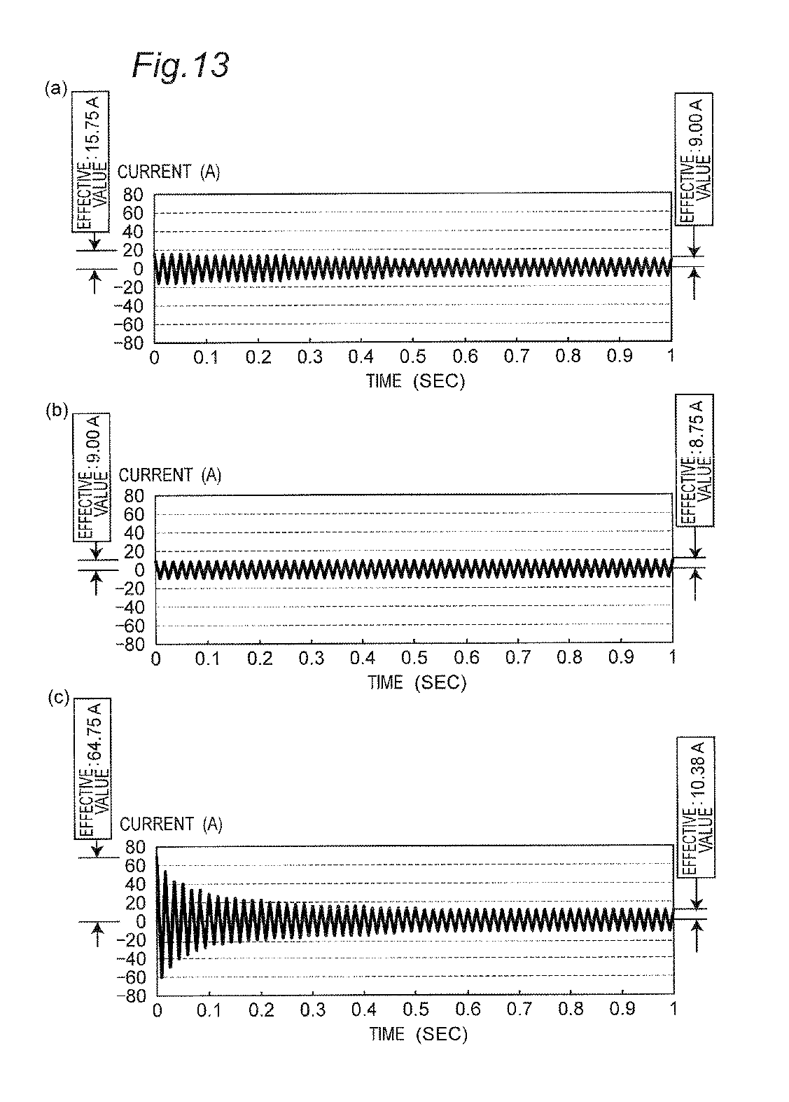

FIG. 13 shows a comparison of the inrush current at initial turn-on among the heaters, showing each current waveform from initial turn-on until after a lapse of 1.0 second. In FIG. 13, (a) is the current waveform diagram at start-up of the heat generating unit 22 used in the image fixing device of the present invention; (b) is the current waveform diagram at start-up of the conventional carbon heater; and (c) is the current waveform diagram at start-up of the halogen heater.

As shown in (a) of FIG. 13, with the heat generating unit 22 used in the image fixing device of the present invention, the effective value of the current at initial turn-on was 15.75 A, and the effective value of the current after a lapse of 1.0 second from the initial turn-on was 9.00 A. That is, with the heat generating unit 22, while occurrence of the inrush current can be seen, the magnitude thereof is twice as great as the current when lighting equilibrium is reached, or smaller than that.

As to the carbon heater shown in (b) of FIG. 13, the inrush current occurred little; the effective value of the current at initial turn-on was 9.00 A; and the effective value of the current after a lapse of 1.0 second from the initial turn-on was 8.75 A. On the other hand, as to the halogen heater shown in (c) of FIG. 13, a great inrush current occurred; the effective value of the current at initial turn-on was 64.75 A; and the effective value of the current after a lapse of 1.0 second from the initial turn-on was 10.38 A. As to the halogen heater, as shown in FIG. 11 (by the alternate long and short dash line Z), the resistance change rate between a state without energization and a state where lighting equilibrium is reached is a great value of 9.27, which is at least five times greater and, therefore, a great inrush current occurs. While occurrence of such a great inrush current exhibits the quicker start up characteristic, it is associated with a problem that a large capacity element that withstands the large current must be used in any appliance in which the halogen heater is used. For example, a thyristor as a switching element of a large current capacity is required. Further, as to a mechanical contact also, a contact of a large breaking capacity must be used in order not to be welded by a large current. Further, as to the halogen heater, it is difficult to exert voltage control due to its principle of heat generation (halogen cycle), and what can be controlled is solely the switching between on and off. Accordingly, it is associated with a problem that the temperature control with great accuracy is impossible.

As described in the foregoing, with the heat generating unit 22 used in the image fixing device according to the fifth embodiment of the present invention, the rate of change between the state without energization and the state where lighting equilibrium is reached is 1.81, and it has the characteristic that a certain amount of inrush current occurs. Therefore, it implements a heat source that starts up quicker; that has shorter time until lighting equilibrium is reached; and that has an excellent response. Consequently, use of the heat generating unit 22 as the heat source of the image fixing device improves the performance as the image fixing device, and implements an appliance that achieves energy savings with its small energy consumption.

Further, because the heat generating unit 22 used in the image fixing device according to the fifth embodiment of the present invention has such a characteristic that it is free of occurrence of a great inrush current that the halogen heater suffers from, it is not necessary to prepare a large-capacity appliance that withstands a large current as the appliance with which the heat generating unit 22 is used, whereby a reduction in the manufacturing cost and miniaturization can be achieved. It is to be noted that, as used herein, the great inrush current refers to the current at initial turn-on that is at least five times as great as the current after a lapse of 1.0 second.

In the heat generating unit 22 used in the image fixing device according to the fifth embodiment of the present invention, it is set such that the current at initial turn-on becomes 3.5 times as great as the current after a lapse of 1.0 second from the initial turn-on, or smaller than that. In this manner, by setting such that, in the heat generating unit 22, the current at initial turn-on becomes 3.5 times as great as the current after a lapse of 1.0 second from the initial turn-on, or smaller than that, a heat source that starts up quick and that has an excellent response is implemented. Further, it is not necessary to use a large-capacity appliance that withstands a large current as the appliance with which the heat generating unit is used, whereby a reduction in the manufacturing cost and miniaturization can be achieved.

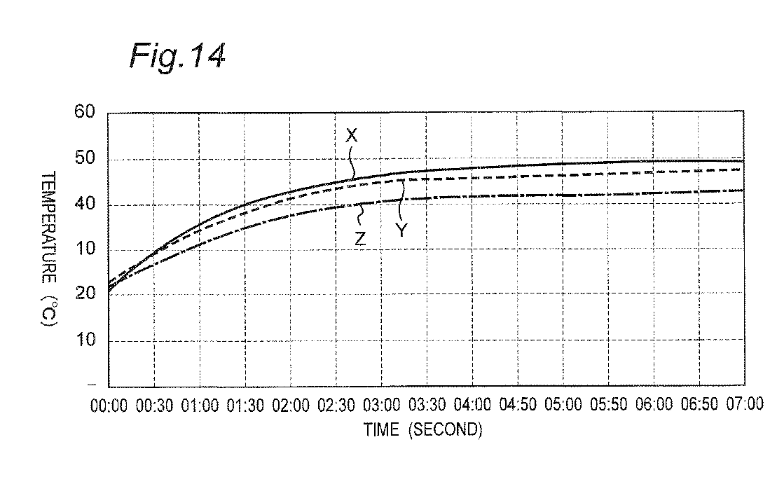

FIG. 14 shows a measurement result of copper plate temperatures when a copper plate as a heating target object is heated by each of the heat generating unit 22, the carbon heater, and the halogen heater. In FIG. 14, the solid line X represents the temperature rise curve of the copper plate by use of the heat generating unit 22. The broken line Y represents the temperature rise curve of the copper plate by use of the carbon heater, and the alternate long and short dash line Z represents the temperature rise curve of the copper plate by use of the halogen heater.

In the copper plate temperature measurement experiment shown in FIG. 14, a copper plate piece measuring 65 mm (L)×65 mm (W)×0.5 mm (t) was used as the heating target object, and the heated face facing the heater serving as the heating element was painted black. Each of the heaters used was an elongated heater having a length of 300 mm, and of 100V- and 600 W-specification. The opposing distance between the copper plate piece and each heater was 300 mm, and the copper plate temperature was measured by attaching a thermocouple to the back surface of the copper plate piece, which is counter to the heated face.

As shown in FIG. 14, the heat generating unit 22 used in the image fixing device according to the fifth embodiment of the present invention raises the temperature of the copper plate serving as the heating target object the fastest and to the high temperature, despite the heat generating unit 22 having the same specification as the other heaters. As to the halogen heater, while the tungsten wire serving as its heat generating element achieves the high temperature, the temperature rise of the heating target object is sluggish because the emissivity of tungsten (about 0.18) is small. While the temperature rise caused by the carbon heater is faster than that caused by the halogen heater, it is more sluggish than the temperature rise caused by the heat generating unit 22, and the equilibrium temperature is also lower. This is because the heat generating element 2 of the heat generating unit 22 exhibits the emissivity of 0.9, which is higher as compared with the emissivity of carbon, i.e., 0.85.

Accordingly, it can be understood that the heat generating unit 22 used in the image fixing device according to the fifth embodiment of the present invention can heat the heating target object highly efficiently and quickly.

As has been described in the foregoing, the heat generating element 2 used in the image fixing device according to the fifth embodiment has such excellent characteristics that it is lightweight and thin, being small in heat capacity, and that it quickly starts up to establish lighting equilibrium upon energization. Accordingly, because the heat generating unit having the heat generating element that responses in an excellent manner and that heats highly efficiently is used in the image fixing device according to the fifth embodiment, heating of the fixing region becomes quicker, whereby energy savings can be achieved and the quick start can be realized. Further, the image fixing device according to the fifth embodiment is free of a great inrush current at an initial stage of heating when lit, the problems such as the occurrence of voltage drop, the occurrence of a flicker, i.e., a fluorescent lamp flickers, are overcome.

The heat generating unit and the heating apparatus of the present invention uses the heat generating element structured with the film sheet raw material whose main component is a carbon-based substance, having the two-dimensional isotropic thermal conduction, possessing flexibility, pliability, and elasticity, having a thermal conductivity of equal to or greater than 200 W/m·K, and having a thickness of equal to or smaller than 300 μm. The heat generating element has the excellent characteristic in exhibiting a high emissivity that is equal to or higher than 80%. The heat generating unit using the heat generating element as a heat source realizes highly efficient heating. Further, use of the heat generating unit of the present invention in the heating apparatus makes it possible to provide a heating apparatus having great safety and reliability, and which can be manufactured easily. Still further, the image fixing device and the image forming device using the heat generating unit of the present invention provide the effect being advantageous in that the heating target object can be heated with a desired heat distribution at high temperatures with high efficiency in the fixing process, that they can start up quickly, and that they can reduce the energy consumption.

### INDUSTRIAL APPLICABILITY

The present invention provides a heat generating unit and a heating apparatus implementing a heat source exhibiting great safety and reliability, together with high efficiency. Therefore, it is useful in the field of electronic electric appliances where a heat source is required.

1. A heat generating unit, comprising:
a band-like heat generating element that is formed with a film sheet of a material including a carbon-based substance and that has a plurality of slits each formed at an oblique angle with respect to an axis being parallel to the longitudinal direction of the heat generating element;
a power supply portion supplying electric power to both ends in a longitudinal direction of the heat generating element; and
a container that contains the heat generating element and part of the power supply portion, wherein
the plurality of slits of the heat generating element include a plurality of first slits extending in parallel from both edge portions opposing to each other along the longitudinal direction of the heat generating element, and further include a plurality of second slits arranged at prescribed intervals so as to alternate with the plurality of first slits and to be in parallel to the first slits,
the plurality of second slits are formed at a central portion in a width direction perpendicular to the longitudinal direction of the heat generating element, thereby forming a current path at each of edge portions defined between respective both ends of the second slits and respective both edge portions opposing to each other along the longitudinal direction of the heat generating element, and
the heat generating element is tensely arranged inside the container by the power supply portion, whereby the heat generating element expands in the longitudinal direction of the heat generating element, and a cross section of the heat generating element in the width direction perpendicular to the longitudinal direction of the heat generating element attains a curved shape.

2. (canceled)

3. (canceled)

4. The heat generating unit according to claim 1, wherein
the first slits and the second slits in the heat generating element are formed by one of through slots or cuts.

5. (canceled)

6. The heat generating unit according to claim 1, wherein
a cross section of the container taken perpendicularly to a longitudinal direction of the container is circular, the heat generating element without being tensely arranged by the power supply portion has a width direction dimension longer than an inner diameter of the container, the width direction being perpendicular to the longitudinal direction of the heat generating element.

7. The heat generating unit according to claim 1, wherein
the heat generating element has an interlayer structure formed of the material including the carbon-based substance.

8. The heat generating unit according to claim 1, wherein
the container is structured with one of a heat resistant glass tube and a heat resistant ceramic tube, the container being sealed at the power supply portion, and having its inside filled with an inert gas.

9. A heating apparatus having installed therein the heat generating unit according to claim 1 as a heat source.

10. An image fixing device, comprising:
a heating element that heats a recording target member carrying an unfixed toner image with a heat generating unit according to claim 1 as a heat source; and
a pressurizing element that is arranged so as to oppose to the heating element, and that pressurizes against the heating element with the recording target member interposed.

11. The image fixing device according to claim 10, wherein
the heat generating element has an interlayer structure formed of the material including the carbon-based substance.

12. The image fixing device according to claim 11, wherein
the heat generating element has a resistance change rate value falling within a range of 1.2 to 3.5, the resistance change rate value being obtained by dividing a resistance value in a state where lighting equilibrium is reached by energization by a resistance value in a state without energization, the heat generating element having a positive temperature coefficient characteristic in which a heat generating element temperature and a resistance value are proportional to each other.

13. The image fixing device according to claim 12, wherein
the heat generating element is a thin membrane element having a thickness of equal to or smaller than 300 μm.

14. The image fixing device according to claim 12, wherein
the heat generating element is a lightweight membrane element having a density of equal to or smaller than 1.0 g/cm³.

15. The image fixing device according to claim 12, wherein
the heat generating element has a two-dimensional isotropic thermal conduction, and is formed of a material having a thermal conductivity of equal to or greater than 200 W/m·K.

16. The image fixing device according to claim 12, wherein
the heating element includes a container that accommodates the heat generating element and part of a power supply portion supplying electric power to opposing both ends of the heat generating element, the container being structured to have its inside filled with an inert gas and to be sealed at the power supply portion.

17. The image fixing device according to claim 12, wherein
the heating element is provided with a reflection portion for defining a heating region to be heated by the heat generating element.

18. The image fixing device according to claim 12, wherein
the heating element is provided with the heat generating element in a plurality of numbers, respective center axes in the longitudinal direction of the plurality of heat generating elements being arranged on a straight line so as to be perpendicular to a conveying direction of the recording target member.

19. The image fixing device according to claim 12, wherein
in the heating element, a membrane element is formed with a member that absorbs infrared radiation at a face facing the heat generating element.

20. The image fixing device according to claim 12, wherein
a heated range heated by the heat generating element includes a nip portion serving as a pressed site of the recording target member pressed by the heating element and the pressurizing element, and a site located upstream relative to the nip portion in a conveying direction of the recording target member.

21. An image forming device comprising the image fixing device according to claim 10.
